(19) United States
(12) Patent Application Publication
(10) Pub. No.: US 2023/0088958 A1
(43) Pub. Date: Mar. 23, 2023

(54) NON-CORROSIVE FORMULATION COMPOSITION FOR NITROGEN INHIBITORS

(71) Applicant: Verdesian Life Sciences U.S., LLC, Cary, NC (US)

(72) Inventors: Janice Paletta, Durham, NC (US); Gary ORR, Pittsboro, NC (US); Kuide QIN, Chapel Hill, NC (US)

(21) Appl. No.: 17/801,949

(22) PCT Filed: Feb. 25, 2021
(86) PCT No.: PCT/US2021/019550

§ 371 Date: Aug. 24, 2022

Related U.S. Application Data
(60) Provisional application No. 62/981,805, filed on Feb. 26, 2020.

(51) Int. Cl. C05G 3/90; A01N 25/02; A01N 43/40

(52) U.S. Cl. CPC C05G 3/90; A01N 25/02; A01N 43/40

(57) ABSTRACT

The presently disclosed subject matter is directed to nitrapyrin-organic acid ionic mixtures and syntheses thereof finding particular utility in agricultural uses, e.g., directly applied to soil, or in combination with fertilizers to increase nutrient uptake and to inhibit nitrification and urease hydrolysis. More particularly, the subject matter is directed to nitrapyrin-organic acid ionic mixtures and formulations thereof that exhibit reduced corrosion behavior compared to nitrapyrin-containing formulations that do not contain ionic mixtures of nitrapyrin with organic acids. Uses of such ionic mixtures of nitrapyrin and organic acids and formulations thereof are also disclosed.

### FIELD

The presently disclosed subject matter relates to liquid formulation compositions comprising the nitrification inhibitor nitrapyrin, an organic acid that is capable of forming ionic mixtures with nitrapyrin, and one or more polar solvents that can dissolve the nitrapyrin and organic acid ionic mixture.

### BACKGROUND

Nitrogen fertilizer added to the soil is readily transformed through a number of biological and chemical processes, including nitrification, leaching, and evaporation. Many transformation processes are undesirable because they reduce the level of nitrogen available for uptake by the targeted plant. The decrease in available nitrogen requires the addition of more nitrogen rich fertilizer to compensate for the loss of agriculturally active nitrogen available to the plants. Nitrification is the process by which certain widely occurring soil bacteria metabolize the ammonium form of nitrogen in the soil transforming the nitrogen into nitrite and nitrate forms, which are more susceptible to nitrogen loss through leaching or volatilization via denitrification. These concerns require improved management of nitrogen for economic efficiency and protection of the environment.

Nitrogen nutrient use efficiency enhancing compounds attempt to reduce nitrification. These so-called nitrification inhibitors have been developed to inhibit nitrogen loss due to nitrification. One class of nitrification inhibitors in use is composed of various chlorinated compounds related to pyridine, as taught by Goring in U.S. Pat. No. 3,135,594 (incorporated herein in its entirety by reference). Nitrapyrin is an example of a nitrification inhibitor.

Current formulations consist of nitrapyrin dissolved in large volumes of volatile, flammable, toxicologically problematic, environmentally problematic, and/or highly odoriferous aromatic solvents (e.g., toluene, xylenes, etc.). For every unit weight of nitrapyrin delivered to the field, more than 3-4 unit weights of such solvents are also delivered to the same soil. The relatively low concentration of active ingredient contributes to increased shipping costs, increased difficulty of handling, and reduced efficiency. Furthermore, once nitrapyrin has been employed, it suffers from significant losses to the atmosphere, resulting in undesirable environmental effects, loss of efficacy of product by way of potency loss, and offensive odors.

Often the nitrapyrin formulations are first mixed into a form of liquid nitrogen fertilizer solution (e.g., UAN and anhydrous ammonia) or coated to the granular nitrogen fertilizer (e.g., urea). When the formulated nitrapyrin composition is in contact with water, either through the liquid fertilizer solution or moisture from the air, the corrosivity of the nitrapyrin formulation will cause equipment failure which is used to apply the nitrapyrin incorporated fertilizer products. The corrosion is typically observed in the metal components of the fertilizer application equipment where the components are in contact with the nitrapyrin formulation. The equipment failure causes down time during the limited fertilizer application season and significant economic losses.

Therefore, it would be highly desirable to find a way to depress nitrapyrin volatilization without resorting to costly techniques and using formulations that are more economical, less toxic, less corrosive, and less harmful to the environment.

### BRIEF SUMMARY

In one aspect, the subject matter described herein is directed to nitrapyrin-organic acid ionic mixtures, various uses thereof, alone or in conjunction with other compounds. The organic acid can be an acid having two or more negatively charged groups. Negatively charged groups include, but are not limited to, carboxyl groups, sulfonate groups, phosphonate groups, and mixtures thereof. The nitrapyrin-organic acid ionic mixtures can further comprise a polyanionic polymer and/or a surface active agent.

In one aspect, the subject matter described herein is directed to noncorrosive formulations comprising nitrapyrin-organic acid ionic mixtures and an organic solvent. Such formulations exhibit no freezing issues when applied to fields and/or crops at cooler temperatures. Such formulations also exhibit a higher loading/concentration and lower volatility of nitrapyrin when compared to N-Serve® and/or Instinct® II.

In one aspect, the subject matter described herein is directed to a composition comprising an agricultural product and a nitrapyrin-organic acid ionic mixture.

In one aspect, the subject matter described herein is directed to a composition comprising a nitrapyrin-organic acid ionic mixture and an organic solvent (e.g., a combination of two or more polar organic solvents), wherein the concentration of nitrapyrin is above about 20% wt.

In some embodiments, the disclosed nitrapyrin-organic acid ionic mixture exhibits decreased volatilization in appropriate solvents when compared to nitrapyrin alone dissolved in solvent or when compared to known commercial nitrapyrin formulations (e.g., N-Serve® and/or Instinct® II).

In some embodiments, the subject matter described herein is directed to formulations suitable for use in agriculture, where the formulations comprise a described nitrapyrin-organic acid ionic mixture.

In some embodiments, the disclosed nitrapyrin-organic acid ionic mixture and/or formulations thereof exhibit decreased corrosive behavior towards materials (e.g., metal-based materials) found in agricultural equipment.

In some embodiments, the disclosed nitrapyrin-organic acid ionic mixture and/or formulations thereof can be applied to fields and/or crops at cooler temperatures without exhibiting any freezing issues.

In some embodiments, the subject matter described herein is directed to methods of increasing plant growth, yields, and health, by contacting a composition comprising a described nitrapyrin-organic acid ionic mixture with the plant or soil in the area of the plant.

In some embodiments, the subject matter described herein is directed to methods of decreasing nitrification and/or reducing atmospheric ammonia.

In some embodiments, the subject matter described herein is directed to methods of preparing the disclosed nitrapyrin-organic acid ionic mixture and compositions and formulations containing a nitrapyrin-organic acid ionic mixture.

These and other aspects are fully described below.

### DETAILED DESCRIPTION

The presently disclosed subject matter will now be described more fully hereinafter. However, many modifications and other embodiments of the presently disclosed subject matter set forth herein will come to mind to one skilled in the art to which the presently disclosed subject matter pertains having the benefit of the teachings presented in the foregoing descriptions. Therefore, it is to be understood that the presently disclosed subject matter is not to be limited to the specific embodiments disclosed and that modifications and other embodiments are intended to be included within the scope of the appended claims. In other words, the subject matter described herein covers all alternatives, modifications, and equivalents. In the event that one or more of the incorporated literature, patents, and similar materials differs from or contradicts this application, including but not limited to defined terms, term usage, described techniques, or the like, this application controls. Unless otherwise defined, all technical and scientific terms used herein have the same meaning as commonly understood by one of ordinary skill in this field. All publications, patent applications, patents, and other references mentioned herein are incorporated by reference in their entirety.

Advantageously, the compositions and methods described herein have been shown to provide desirable properties for the use of nitrapyrin in agriculture by formulating nitrapyrin with an organic acid that is capable of forming ionic mixtures with nitrapyrin, and one or more of polar solvents that can dissolve the nitrapyrin and organic acid ionic mixture. These properties include, but are not limited to: low cost, higher actives content relative to marketed products, ease of preparation, ease of handling, high solubility in certain solvents, excellent environmental and toxicology profiles, low-temperature field application ability, reduced level of corrosion towards materials found in agricultural application equipment (e.g., metal-based materials), and non-liquid dosage forms. As disclosed herein, among other properties, the nitrapyrin-organic acid ionic mixtures have significantly lower vapor pressure, thereby reducing volatilization; increased solubility, thereby providing compositions with high loading and/or concentration; and increased stability (i.e., chemically) when formulated in an environment with reduced water content. In addition to increased chemical stability, high thermal stability is observed as well with the nitrapyrin-organic acid ionic mixtures disclosed herein.

The reduced volatility of the nitrapyrin-organic acid ionic mixtures and compositions containing the nitrapyrin-organic acid ionic mixtures provides longer lasting effectiveness once applied to fields and/or crops, and furthermore can be applied at a much lower product application dose rate. Next, the nitrapyrin-organic acid ionic mixtures and compositions containing such ionic mixtures exhibit no freezing issues (such as changes in viscosity, partial or complete solidification, partial of complete freezing, slushy formation, and/or crystal formation) during cold temperature applications (e.g., around freezing temperatures and below). Lastly, the nitrapyrin-organic acid ionic mixtures and compositions containing such ionic mixtures exhibit a reduced level of corrosion ability towards materials used in agricultural equipment, particularly metal-based materials.

Heretofore, methods found in the art for reducing volatility of materials involving pyridine derivatives involved an approach extremely different than the methods disclosed herein. For example, the use of poly(4-vinylpyridine) sulfur trioxide complex is known to the art of sulfonation chemistry, wherein the volatility of sulfur trioxide is controlled by formation of a complex with poly(vinylpyridine). In this example, the pyridine derivative part of the molecule is the non-volatile portion, whereas the sulfur trioxide is the volatile portion. By contrast, the distinctly different approach as described herein utilizes nitrapyrin-organic acid ionic mixtures as a non-volatile component and a pyridine derivative, such as nitrapyrin as a volatile component.

Unexpectedly, these ionic mixtures also exhibit a reduced level of corrosion towards materials used in agricultural equipment, particularly metal-based materials, compared to other nitrapyrin containing formulations.

### I. Definitions

As used therein, the term “ionic mixture” refers to a liquid composition that is in a salt or chelate form containing nitrapyrin and one or more organic acids.

As used herein, the term “complex” or “complex substance” refers to chelates and coordination complexes of nitrapyrin, wherein nitrapyrin associates with functional groups of organic acid(s) in a covalent (i.e., bond forming) or non-covalent (e.g., ionic, hydrogen bonding, or the like) manner. In a complex, a central moiety or ion (e.g., nitrapyrin) associates with a surrounding array of bound molecules or ions known as ligands or complexing agents (e.g., organic acid(s)). The central moiety binds to or associates with several donor atoms of the ligand, wherein the donor atoms can be the same type of atom or can be a different type of atom. Ligands or complexing agents bound to the central moiety through several of the ligand's donor atoms forming multiple bonds (i.e., 2, 3, 4 or even 6 bonds) are referred to a polydentate ligand. Complexes with polydentate ligands are called chelates. Typically, complexes of central moieties with ligands are increasingly more soluble than the central moiety by itself because the ligand(s) that surround(s) the central moiety do not dissociate from the central moiety once in solution and solvates the central moiety thereby promoting its solubility.

As used herein, the term “salt” refers to chemical compounds consisting of an assembly of cations and anions. Salts are composed of related numbers of cations (positively charged ions) and anions (negative ions) so that the product is electrically neutral (without a net charge). Many ionic compounds exhibit significant solubility in water or other polar solvents. The solubility is dependent on how well each ion interacts with the solvent.

As used herein, the term “organic acid” refers to an organic compound with acidic properties. An organic compound must contain at least one or more carbon atoms that are coavalently linked to atoms of other elements such as hydrogen, oxygen, or nitrogen. The most common organic acids are the carboxylic acids, whose acidity is associated with their carboxyl group —COOH. However organic compounds containing sulfonic acid groups (—S(═O)₂OH) and phosphonic acid groups (—PO(OH)₂ or —PO(OR)₂, where R=alkyl) are also considered organic acids.

As used therein, the term “inorganic acid” refers to any acid derived from an inorganic compound that dissociates to produce hydrogen ion [H⁺] and/or hydronium ion [H₃O⁺] in water.

As used herein, the term “soil” is to be understood as a natural body comprised of living (e.g., microorganisms (such as bacteria and fungi), animals and plants) and non-living matter (e.g., minerals and organic matter (e.g., organic compounds in varying degrees of decomposition), liquid, and gases) that occurs on the land surface and is characterized by soil horizons that are distinguishable from the initial material as a result of various physical, chemical, biological, and anthropogenic processes. From an agricultural point of view, soils are predominantly regarded as the anchor and primary nutrient base for plants (plant habitat).

As used herein, the term “fertilizer” is to be understood as chemical compounds applied to promote plant and fruit growth. Fertilizers are typically applied either through the soil (for uptake by plant roots) or by foliar feeding (for uptake through leaves). The term “fertilizer” can be subdivided into two major categories: a) organic fertilizers (composed of decayed plant/animal matter) and b) inorganic fertilizers (composed of chemicals and minerals). Organic fertilizers include manure, slurry, worm castings, peat, seaweed, sewage, and guano. Green manure crops are also regularly grown to add nutrients (especially nitrogen) to the soil. Manufactured organic fertilizers include compost, blood meal, bone meal and seaweed extracts. Further examples are enzymatically digested proteins, fish meal, and feather meal. The decomposing crop residue from prior years is another source of fertility. In addition, naturally occurring minerals such as mine rock phosphate, sulfate of potash and limestone are also considered inorganic fertilizers. Inorganic fertilizers are usually manufactured through chemical processes (such as the Haber-Bosch process), also using naturally occurring deposits, while chemically altering them (e.g., concentrated triple superphosphate). Naturally occurring inorganic fertilizers include Chilean sodium nitrate, mine rock phosphate, and limestone.

As used herein, the term “manure” is organic matter used as organic fertilizer in agriculture. Depending on its structure, manure can be divided into liquid manure, semi-liquid manure, stable or solid manure, and straw manure. Depending on its origin, manure can be divided into manure derived from animals or plants. Common forms of animal manure include feces, urine, farm slurry (liquid manure), or farmyard manure (FYM), whereas FYM also contains a certain amount of plant material (typically straw), which may have been used as bedding for animals. Animals from which manure can be used comprise horses, cattle, pigs, sheep, chickens, turkeys, rabbits, and guano from seabirds and bats. The application rates of animal manure when used as fertilizer highly depends on the origin (type of animals). Plant manures may derive from any kind of plant whereas the plant may also be grown explicitly for the purpose of plowing them in (e.g., leguminous plants), thus improving the structure and fertility of the soil. Furthermore, plant matter used as manure may include the contents of the rumens of slaughtered ruminants, spent hops (left over from brewing beer) or seaweed.

As used herein, the term “seed” comprises seed of all types, such as, for example, corns, seeds, fruits, tubers, seedlings, and similar forms. The seed used can be seed of the useful plants mentioned above, but also the seed of transgenic plants or plants obtained by customary breeding methods.

As used herein, the term “reduce volatility” and the like refers to the volatility of the nitrapyrin-organic acid ionic mixture as compared to that of the nitrapyrin-free base. The reduction in volatility can be quantified as described elsewhere herein.

As used herein, the term “organic solvent” refers to a non-aqueous solvent that solvates the nitrapyrin-organic acid ionic mixture to the degree as described elsewhere herein.

As used herein, the term “thermal stability” refers to the stability of a substance when exposed to a thermal stimulus over a given period of time. Examples of thermal stimuli include, but are not limited to, dramatic changes in external/environmental temperature due to changes in weather and/or season, e.g., an increase in temperature due to the sun and/or a decrease in temperature due to freezing/snowing.

As used herein, the term “chemical stability” refers to the resistance of a substance to structural change when exposed to an external action such as air (which can lead to oxidation), light (e.g., sun light), moisture/humidity (from water), heat (from the sun), cold (due to seasonal changes) and/or chemical agents. Exemplary chemical agents include, but are not limited to, any organic or inorganic substance that can degrade the structural integrity of the compound of interest (e.g., the disclosed nitrapyin-organic acid ionic mixture).

As used herein, the term “inhibit urease” and the like refers to the inhibition of the activity of urease. The inhibition can be quantified as described elsewhere herein.

As used herein, “nitrification inhibitor” refers to a property of a compound, such as nitrapyrin, to inhibit oxidation of ammonia to nitrite/nitrate.

As used herein, “N-Serve®” refers to a composition comprising nitrapyrin at a concentration of 22.2% relative to the total solution. The solution comprises petroleum distillates as a solvent. The composition is formulated at a concentration of 2 lbs of active ingredient (nitrapyrin) per gallon.

As used herein, “Instinct® II” refers a composition comprising nitrapyrin at a concentration of 16.95% relative to the total solution. The solution comprises petroleum distillates as a solvent. The composition is formulated at a concentration of 1.58 lbs of active ingredient (nitrapyrin) per gallon.

Additional definitions may follow below.

### II. Compositions

Ionic mixtures of nitrapyrin and an organic acid have been prepared. As discussed herein, these ionic mixtures can exhibit desirable properties such as a significantly lower vapor pressure, higher loading, increased chemical and/or thermal stability (particularly high thermal stability at different temperatures), a reduced level of corrosiveness towards metal-based and/or plastic-based materials, and a lack of freezing issues at lower temperatures, all of which generally contribute to an increased performance in the field.

Generally, the nitrapyrin-organic acid ionic mixtures can be used neat or can include an organic solvent, as well as other ingredients to form useful compositions. In some embodiments, the organic solvent comprises one or more polar solvents. The amount of organic solvent can vary. In some embodiments, the organic solvent is present in the composition in an amount ranging from about 10% to about 70%, from about 20% to about 70% from about 30% to about 70% from about 40% to about 70%, from about 50% to about 70%, from about 50% to about 65%, or from about 60% to about 70% based on the total weight of the composition.

In some embodiments, the described compositions and formulations contain relatively little to no water. Formulations containing high amounts of water have shown rapid degradation of nitrapyrin and therefore the exposure of nitrapyrin to excessive amounts of water should be minimized. In some embodiments, the amount of water present in neat nitrapyrin-organic acid ionic mixture or in a formulation thereof containing an organic solvent is less than about 10%, about 9%, about 8%, about 7%, about 6%, about 5%, about 4%, about 3%, about 2%, about 1%, or is less than 0.5% w/w based on the total weight of the composition. In such composition the chemical stability of the nitrapyrin-organic acid ionic mixture is at least about 50%, about 60%, about 70%, about 80%, about 85%, about 90%, about 91%, about 92%, about 93%, about 94%, about 95%, about 96%, about 97%, about 98%, about 99%, or at least about 99.5%. See for example, Meikle et al. “The hydrolysis and photolysis rates of nitrapyrin in dilute aqueous solution” Arch. Envt'l. Contain. & Toxicol. 7, 149-158 (1978). In some embodiments, the chemical stability of the nitrapyrin-organic acid ionic mixtures is a function of the chemical purity of the nitrapyrin-organic acid ionic mixtures and/or compositions thereof. Typically, a decrease in chemical stability of nitrapyrin-organic acid ionic mixtures and/or compositions thereof having one or more minor impurities present is observed compared to pure nitrapyrin-organic acid ionic mixtures and/or compositions thereof.

A. Nitrapyrin—Organic Acid Ionic Mixtures

Nitrapyrin is a nitrification inhibitor having the structure:

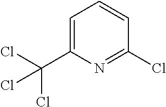 [SMILES: Clc1cccc(C(Cl)(Cl)Cl)n1]

It functions to inhibit nitrification within the soil bacteria, Nitrosomonas, which act on ammonia by oxidizing ammonium ions to nitrite and/or nitrate. Nitrification inhibition therefore reduces nitrogen emissions from soil.

Organic acids employed in the formation of nitrapyrin-organic acid ionic mixtures include, but are not limited to, acids having a plurality (two or more) of anionic functional groups, including, but not limited to, carboxylates, sulfonates, phosphonates, or a combination thereof. Organic acids include, but are not limited to, di-, tri-, tetra-, penta-, hexa-, hepta-, octa-, nona-, and deca-carboxyls, di-, tri-, tetra-, penta-, hexa-, hepta-, octa-, nona-, and deca-sulfonates, and di-, tri-, tetra-, penta-, hexa-, hepta-, octa-, nona-, and deca-phosphonates. In some embodiment, an organic acid comprises an aliphatic dibasic acid. In some embodiments, an organic acid comprises aromatic carboxylic acid containing a 2-6 carboxylic acid group. In some embodiments, an organic acid comprises aliphatic carboxylic acid containing a 2-6 carboxylic acid group. Exemplary organic acids that are polycarboxylic acids, phosphonates, and aromatic carboxylic acids suitable for forming nitrapyrin-organic acid ionic mixtures include, but are not limited to, malic acid, tartaric acid, etidronic acid, succinic acid, adipic acid, isophthalic acid, aconitic acid, trimesic acid, biphenyl-3,3′,5,5′-tetracarboxylic acid, furantetracarboxylic acid, sebacic acid, azelaic acid, isophthallic acid, pyromellitic acid, mellitic acid, and a combination thereof.

Organic acids suitable for formation of useful ionic mixtures with nitrapyrin have one or more of: a formal charge of −2 or greater (i.e., greater negative charge) in dilute aqueous solution at pH 10, lower vapor pressure when compared to the vapor pressure of nitrapyrin, and/or lower volatility when compared to the volatility of nitrapyrin. In some embodiments, the vapor pressure of the nitrapyrin in the nitrapyrin-organic acid ionic mixture is less than 0.5 mm Hg at 20° C. Furthermore, the amount of loading of the nitrapyrin into a formulation has been significantly increased. Such formulations typically exhibit a lower use rate compared to nitrapyrin formulations that do not contain nitrapyrin-organic acid ionic mixtures.

In some embodiments, the nitrapyrin-organic acid ionic mixture comprises two or more organic acids, wherein the two or more organic acids are different.

In some embodiments, the nitrapyrin-organic acid ionic mixture further comprises a polyanionic polymer. Exemplary polyanionic polymers include polyanionic polymers disclosed in WO 2011/016898; WO 2015/031521; US2016/0102027; US2017/0183492; and U.S. Pat. No. 10,059,636, each of which is incorporated by reference in its entirety.

In some embodiments, the MW/charge ratio of the polyanionic polymer is 45-200, 45-175, 45-150, 45-125, 45-125, 45-110, 45-105, 45-100, 45-95, 45-90, 45-85, 45-80, 45-75, 50-200, 50-175, 50-150, 50-125, 50-125, 50-110, 50-105, 50-100, 50-95, 50-90, 50-85, 50-80, 50-75, 65-200, 65-175, 65-150, 65-125, 65-125, 65-110, 65-105, 90-115, 90-100, 90-105, 95-120, 95-115, 95-110, 95-105, 50, 55, 60, 65, 70, 75, 80, 85, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 1127, 128, 129, or 130. In some embodiments, the charge ratio (molecular weight/charge) is less than 200, less than 175, less than 150, less than 140, less than 130, less than 125, less than 120, less than 115, less than 110, less than 105, less than 100, less than 95, less than 90, less than 85, less than 80, less than 75, or less than 70. In some embodiments, the MW/charge ratio of the polyanionic polymer is greater than 50, greater than 55, greater than 60, greater than 65, greater than 70, greater than 75, greater than 80, greater than 85, greater than 90, greater than 95, or greater than 100.

In some embodiments, the polyanionic polymer comprises a copolymer containing two or more different repeat units. A copolymer can have two, three, four, or more different repeat units. As used herein, a copolymer contains two or more different repeat units. As used herein, a terpolymer contains three or more different repeat units. As used herein, a tetrapolymer contains four or more different repeat units. A polyanionic polymer can be, but is not limited to, random copolymer, alternating copolymer, periodic copolymer, statistical copolymer, or block copolymer. In some embodiments, the polyanionic polymer can be a carboxylated polymer, a sulfonated polymer or an all-sulfonated polymer. An all-sulfonated polymer can be, but is not limited to, polystyrene sulfonate. Additionally, the sulfur can be provided by polyanionic species such as ethanedisulfonic acid and 1,3-benzenedisulfonic acid.

In some embodiments, the polyanionic polymers have a high carboxylate content and sulfonate repeat units, which are very soluble in water and biodegradable. In some embodiments, a polyanionic polymer has a single repeating unit, wherein the repeating unit contains a negatively charged group. In some embodiments, a polyanionic polymer comprises a copolymer having two or more repeating units wherein at least one of the repeating units contains a negatively charged group. In some embodiments, a polyanionic polymer comprises a dipolymer having two repeating units wherein at one or both of the repeating units contains a negatively charged group. In some embodiments, a polyanionic polymer comprises a terpolymer having three or more repeating units wherein at least one of the repeating units contains a negatively charged group. In some embodiments, the polyanionic polymers are tetrapolymers having at least four different repeat units distributed along the lengths of the polymer chains, preferably with at least one repeat unit each of maleic, itaconic, and sulfonate repeat units. The repeat units are derived from corresponding monomers used in the synthesis of the polymers. In some embodiments, a polyanionic polymer contains type B, type C, and/or type G repeat units as described in detail below. In some embodiments, a polyanionic polymer contains type B and type C, type B and type G, or type C and type G repeat units as described in detail below. In some embodiments, a polyanionic polymer contains at least one repeat unit from each of three separately defined categories of repeat units, referred to herein as type B, type C, and type G repeat units, and described in detail below. In some embodiments, at least about 90 mole percent of the repeat units therein are selected from the group consisting of type B, C, and G repeat units, and mixtures thereof, the repeat units being randomly located along the polyanionic polymer. In some embodiments, the polyanionic polymer contains no more than about 10 mole percent or no more than 5 mole percent of any of (i) non-carboxylate olefin repeat units, (ii) ether repeat units, (iii) non-sulfonated monocarboxylic repeat units, (iv) non-sulfonated monocarboxylic repeat units, and/or (v) amide-containing repeat units. “Non-carboxylated” and “non-sulfonated” refers to repeat units having essentially no carboxylate groups or sulfonate groups in the corresponding repeat units.

In some embodiments, a polyanionic polymer comprises a copolymer comprising the structure represented by:

poly(Aₐ-co-A′_{a′}-co-A″_{a″}-co-D_{d})

wherein A is a first repeat unit containing a negatively charged group, A′ is optional and if present is a second repeat unit containing a negatively charged group, A″ is optional and if present is a third repeat unit containing a negatively charged group, and D is optional and if present is an uncharged repeat unit. A polyanionic polymer can contain additional negatively charged repeat units or uncharged repeat units. a is an integer greater than or equal to 1. a′, a″, and d are integers greater than or equal to zero. The value of (a+a′+a″) is greater than or equal to 2.

In some embodiments, the polyanionic polymer comprises a random copolymer having structure represented by:

poly(B_{b}-co-C_{c}-co-G_{g}-co-G′_{g′})

wherein B and C are type B and type C repeat units as described below, G and G′ are independently type G repeat units as described below, c is an integer greater than zero and b, g and g′ are integers greater than or equal to zero. In some embodiments, the ratio of b:c:(g+g′) is about 1-70:1-80:0-65. In some embodiments, the ratio of b:c:(g+g′) is about 20-65:15-75:1-35. In some embodiments, the ratio of b:c:(g+g′) is about 35-55:20-55:1-25. In some embodiments, the ratio of b+c to g+g′ is about 0.5-20:1, about 1-20:1, or about 1-10:1. In some embodiments, the ratio of b:c:g:g′ is about 10:90:0:0, about 60:40:0:0, about 50:50:0:0, or about 0:100:0:0. In some embodiments, the ratio of b:c:g:g′ is about 45:35:15:5. In some embodiments, the ratio of b:c:g:g′ is about 45:50:4:1. In some embodiments, the polymers contain less than 10%, less than 4%, less than 3%, less than 2%, less than 1%, less than 0.5%, less than 0.1%, less than 0.05%, less than 0.01% or 0% repeat units that are not B, C, G, or G′.

In some embodiments, the polyanionic polymer comprises a tetrapolymer having repeat units individually and independently selected from the group consisting of type B, type C, and type G repeat units, and mixtures thereof, described in detail below. In some embodiments, a tetrapolymer contains more than four different repeat units. In some embodiments, the additional repeat units are selected from the group consisting of type B, type C, and type G repeat units, and mixtures thereof, as well as other monomers or repeat units not being type B, C, or G repeat units.

In some embodiments, a polyanionic polymer contains at least one repeat unit from each of the B, C, and G types, one other repeat unit selected from the group consisting of type B, type C, and type G repeat units, and optionally other repeat units not selected from type B, type C, and type G repeat units. In some embodiments, a polyanionic polymers comprise a single type B repeat unit, a single type C repeat unit, and two different type G repeat units, or two different type B repeat units, a single type C repeat unit, and one or more different type G repeat units.

In some embodiments, the polyanionic polymers comprise at least 90% or at least 96 mole percent of the repeat units therein selected from the group consisting of type B, C, and G repeat units, and mixtures thereof. In some embodiments, the polyanionic polymers consist of or consist essentially of repeat units selected from the group consisting of type B, C, and G repeat units, and mixtures thereof. In some embodiments, the polyanionic polymers contain <3, <2, <1, <0.5, <0.1, <0.05, <0.01, or 0 mole percent ester groups and/or noncarboxylate olefin groups.

In some embodiments, the total amount of type B repeat units in the polymer is from about 1-70 mole percent, the total amount of type C repeat units in the polymer is from about 1-80 mole percent, and the total amount of type G repeat units in the polymer is from about 0.1-65 mole percent, where the total amount of all of the repeat units in the polymer is taken as 100 mole percent. In some embodiments, the total amount of type B repeat units in the polymer is from about 20-65 mole percent, the total amount of type C repeat units in the polymer is from about 15-75 mole percent, and the total amount of type G repeat units in the polymer is from about 1-35 mole percent, where the total amount of all of the repeat units in the polymer is taken as 100 mole percent.

In some embodiments, the polyanionic polymers have one type B repeat unit, one type C repeat unit, and two different type G repeat units. In some embodiments, the one type B repeat unit is derived from maleic acid, the one type C repeat unit is derived from itaconic acid, and two type G repeat units are respectively derived from methallylsulfonic acid and allylsulfonic acid. In such polymers, the type B repeat unit can be present at a level of from about 35-55 mole percent, the type C repeat unit can present at a level of from about 20-55 mole percent, the type G repeat unit derived from methallylsulfonic acid can present at a level of from about 1-25 mole percent, and the type G repeat unit derived from allylsulfonic acid can be present at a level of from about 1-25 mole percent, where the total amount of all of the repeat units in the polymer is taken as 100 mole percent. In other embodiments, the polyanionic polymers comprise two different type B repeat units, one type C repeat unit, and one type G repeat unit. In some embodiments, the polyanionic polymer contains at least one repeat unit not selected from the group consisting of type B, type C, and type G repeat units.

In some embodiments, the mole ratio of the type B and type C repeat units in combination to the type G repeat units (that is, the mole ratio of (B+C)/G) should be about 0.5-20:1, about 2:1-20:1, or about 2.5:1-10:1. Still further, the polymers should be essentially free (e.g., less than about 1 mole percent) of alkyloxylates or alkylene oxide (e.g., ethylene oxide)-containing repeat units, and most desirably entirely free thereof.

In some embodiments, the polyanionic polymers have a high percentage of the repeat units thereof bearing at least one anionic group, e.g., at least about 80 mole percent, at least about 90 mole percent, at least about 95 mole percent, or essentially all of the repeat units contain at least one anionic group. It will be appreciated that the type B and C repeat units have two anionic groups per repeat unit, whereas the preferred sulfonate repeat units have one anionic group per repeat unit.

In some embodiments, a polyanionic terpolymer comprises a polymer backbone composition range (by mole percent, using the parent monomer names of the corresponding repeat units) of: maleic acid 35-50%; itaconic acid 20-55%; methallylsulfonic acid 1-25%; and allylsulfonic sulfonic acid 1-20%, where the total amount of all of the repeat units in the polymer is taken as 100 mole percent.

The molecular weight of the polymers can be varied, depending upon the desired properties. The molecular weight distribution for any of the polyanionic polymers can be measured by size exclusion chromatography. In some embodiments, a polyanionic polymer has a molecule weight greater than 118, greater than 150, greater than 200, greater than 300, greater than 400, or greater than 500 Da. In some embodiments, the polyanionic polymers have a molecular weight of about 100-50,000 Da. In some embodiments, the polyanionic polymers have a molecular weight of about 100-5000 Da, about 200-5000 Da, about 400-5000 Da, or about 1000-5000 Da. In some embodiments, at least 90% of the finished polyanionic polymer is at or above a molecular weight of about 100, 200, 400, or 1000 measured by size exclusion chromatography in 0.1 M sodium nitrate solution via refractive index detection at 35° C. using polyethylene glycol standards. Other methods of determining polymer molecular known in the art can also be employed.

### Type B Repeat Units

Type B repeat units can be selected from the group consisting of repeat units derived from substituted and unsubstituted monomers of maleic acid and/or maleic anhydride, fumaric acid, mesaconic acid, mixtures of the foregoing, and any isomers, esters, acid chlorides, and partial or complete salts of any of the foregoing. Type B repeat units may be substituted with one or more C₁-C₆ straight or branched chain alkyl groups substantially free of ring structures and halo atoms, wherein substantially free means no more than about 5 mole percent or no more than about 1 mole percent of either ring structures or halo substituent. Substituents are normally bound to one of the carbons of a carbon-carbon double bond of the monomer(s) employed.

Those skilled in the art will appreciate the usefulness of in situ conversion of acid anhydrides to acids in a reaction vessel just before or even during a reaction. However, it is also understood that when corresponding esters (e.g., maleic or citraconic esters) are used as monomers during the initial polymerization, this should be followed by hydrolysis (acid or base) of pendant ester groups to generate a final carboxylated polymer substantially free of ester groups.

### Type C Repeat Units

Type C repeat units can be selected from the group consisting of repeat units derived from substituted or unsubstituted monomers of itaconic acid or itaconic anhydride, and any isomers, esters, and the partial or complete salts of any of the foregoing and mixtures of any of the foregoing. Type C repeat units may be substituted with one or more C₁-C₆ straight or branched chain alkyl groups substantially free of ring structures and halo atoms.

The itaconic acid monomer used to form type C repeat unit has one carboxyl group, which is not directly attached to the unsaturated carbon-carbon double bond used in the polymerization of the monomer. In some embodiments, a type C repeat unit has one carboxyl group directly bound to the polymer backbone, and another carboxyl group spaced by a carbon atom from the polymer backbone. The definitions and discussion relating to “substituted,” “salt,” and useful salt-forming cations (metals, amines, and mixtures thereof) with respect to the type C repeat units, are the same as those set forth for the type B repeat units.

In some embodiments, the type C repeat unit is an unsubstituted itaconic acid or itaconic anhydride, either alone or in various mixtures. If itaconic anhydride is used as a starting monomer, it is normally useful to convert the itaconic anhydride monomer to the acid form in a reaction vessel just before or even during the polymerization reaction. Any remaining ester groups in the polymer are normally hydrolyzed, so that the final carboxylated polymer is substantially free of ester groups.

### Type G Repeat Units

Type G repeat units can be selected from the group consisting of repeat units derived from substituted or unsubstituted sulfonated monomers possessing at least one carbon-carbon double bond and at least one sulfonate group and which are substantially free of aromatic rings and amide groups, and any isomers, and the partial or complete salts of any of the foregoing, and mixtures of any of the foregoing. Type G repeat units may be substituted with one or more C₁-C₆ straight or branched chain alkyl groups substantially free of ring structures and halo atoms.

In some embodiments, type G repeat units can be selected from the group consisting of C₁-C₈ straight or branched chain alkenyl sulfonates, substituted forms thereof, and any isomers or salts of any of the foregoing; especially preferred are alkenyl sulfonates selected from the group consisting of vinyl, allyl, and methallylsulfonic acids or salts.

In some embodiments, the type G repeat units are derived from vinylsulfonic acid, allylsulfonic acid, and methallylsulfonic acid, either alone or in various mixtures. It has also been found that alkali metal salts of these acids are also highly useful as monomers. In this connection, it was unexpectedly discovered that during polymerization reactions yielding the novel polymers disclosed herein, the presence of mixtures of alkali metal salts of these monomers with acid forms thereof does not inhibit completion of the polymerization reaction. By the same token, mixtures of monomers of maleic acid, itaconic acid, sodium allyl sulfonate, and sodium methallyl sulfonate do not inhibit the polymerization reaction.

Syntheses of BC and BCG polymers are described in WO 2015/031521, incorporated herein by reference in its entirety.

A.1. Class I Polymers

### Class IA polymers

Class IA polymers contain both carboxylate and sulfonate functional groups, but are not the tetra- and higher order polymers of Class I. For example, terpolymers of maleic, itaconic, and allylsulfonic repeat units will function as the polyanionic polymer component of the compositions. The Class IA polymers thus are normally homopolymers, copolymers, and terpolymers, advantageously including repeat units individually and independently selected from the group consisting of type B, type C, and type G repeat units, without the need for any additional repeat units. Such polymers can be synthesized in any known fashion and can also be produced using the previously described Class I polymer synthesis.

Class IA polymers preferably have the same molecular weight ranges and the other specific parameters (e.g., pH and polymer solids loading) previously described in connection with the Class I polymers, and maybe converted to partial or complete salts using the same techniques described with reference to the Class I polymers. Class IA polymers are most advantageously synthesized using the techniques described above in connection with the Class I polymers.

A.2. Class II Polymers

Broadly speaking, the polyanionic polymers of this class are of the type disclosed in U.S. Pat. No. 8,043,995, which is incorporated herein by reference in its entirety. The polymers include repeat units derived from at least two different monomers individually and respectively taken from the group consisting of what have been denominated for ease of reference as B′ and C′ monomers; alternately, the polymers may be formed as homopolymers or copolymers from recurring C′ monomers. The repeat units may be randomly distributed throughout the polymer chains.

In detail, repeat unit B′ is of the general formula

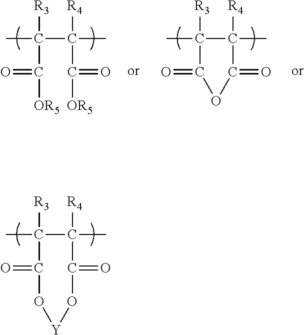

or and repeat unit C is of the general formula

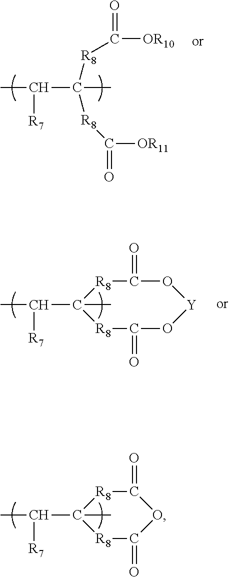

wherein each R₇ is individually and respectively selected from the group consisting of H, OH, C₁-C₃₀ straight, branched chain and cyclic alkyl or aryl groups, C₁-C₃₀ straight, branched chain and cyclic alkyl or aryl formate (C₀), acetate (C₁), propionate (C₂), butyrate (C₃), etc., up to C₃₀ based ester groups, R′CO₂ groups, OR′ groups and COOX groups, wherein R′ is selected from the group consisting of C₁-C₃₀ straight, branched chain and cyclic alkyl or aryl groups and X is selected from the group consisting of H, the alkali metals, NH₄, and the C₁-C₄ alkyl ammonium groups, R₃ and R₄ are individually and respectively selected from the group consisting of H, C₁-C₃₀ straight, branched chain and cyclic alkyl or aryl groups, R₅, R₆, R₁₀ and R₁₁ are individually and respectively selected from the group consisting of H, the alkali metals, NH₄, and the C₁-C₄ alkyl ammonium groups, Y is selected from the group consisting of Fe, Mn, Mg, Zn, Cu, Ni, Co, Mo, V, W, the alkali metals, the alkaline earth metals, polyatomic cations containing any of the foregoing (e.g., VO⁺²), amines, and mixtures thereof; and R₈ and R₉ are individually and respectively selected from the group consisting of nothing (i.e., the groups are non-existent), CH₂, C₂H₄, and C₃H₆.

As can be appreciated, the Class II polymers typically have different types and sequences of repeat units. For example, a Class II polymer comprising B′ and C′ repeat units may include all three forms of B′ repeat units and all three forms of C′ repeat units. However, for reasons of cost and ease of synthesis, the most useful Class II polymers are made up of B′ and C′ repeat units. In the case of the Class II polymers made up principally of B′ and C′ repeat units, R₅, R₆, R₁₀, and R₁₁ are individually and respectively selected from the group consisting of H, the alkali metals, NH₄, and the C₁-C₄ alkyl ammonium groups. This particular Class II polymer is sometimes referred to as a butanedioic methylenesuccinic acid copolymer and can include various salts and derivatives thereof.

The Class II polymers may have a wide range of repeat unit concentrations in the polymer. For example, Class II polymers having varying ratios of B′:C′ (e.g., 10:90, 60:40, 50:50, and even 0:100) are contemplated and embraced by the presently disclosed subject matter. Such polymers would be produced by varying monomer amounts in the reaction mixture from which the final product is eventually produced and the B′ and C′ type repeat units may be arranged in the polymer backbone in random order or in an alternating pattern.

The Class II polymers may have a wide variety of molecular weights, ranging for example from 500-5,000,000, depending chiefly upon the desired end use. Additionally, n can range from about 1-10,000 and more preferably from about 1-5,000.

Class II polymers can be synthesized using dicarboxylic acid monomers, as well as precursors and derivatives thereof. For example, polymers containing mono- and dicarboxylic acid repeat units with vinyl ester repeat units and vinyl alcohol repeat units are contemplated; however, polymers principally comprised of dicarboxylic acid repeat units are preferred (e.g., at least about 85%, and more preferably at least about 93%, of the repeat units are of this character). Class II polymers may be readily mixed with salt-forming cations using conventional methods and reactants.

In some embodiments, the Class II polymers are composed of maleic and itaconic B′ and C′ repeat units and have the generalized formula:

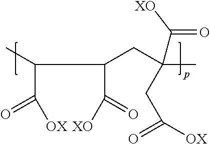

where X is either H or another salt-forming cation, depending upon the level of salt formation.

In a specific example of the synthesis of a maleic-itaconic Class II polymer, acetone (803 g), maleic anhydride (140 g), itaconic acid (185 g), and benzoyl peroxide (11 g) were stirred together under inert gas in a reactor. The reactor provided included a suitably sized cylindrical jacketed glass reactor with mechanical agitator, a contents temperature measurement device in contact with the contents of the reactor, an inert gas inlet, and a removable reflux condenser. This mixture was heated by circulating heated oil in the reactor jacket and stirred vigorously at an internal temperature of about 65-70° C. This reaction was carried out over a period of about 5 hours. At this point, the contents of the reaction vessel were poured into 300 g water with vigorous mixing. This gave a clear solution. The solution was subjected to distillation at reduced pressure to drive off excess solvent and water. After sufficient solvent and water have been removed, the solid product of the reaction precipitates from the concentrated solution and is recovered. The solids are subsequently dried in vacuo.

In some embodiments, the polyanionic polymer has repeat unit molar composition of 45 mole percent maleic repeat units, 50 mole percent itaconic repeat units, 4 mole percent methallylsulfonate repeat units, and 1 mole percent allylsulfonate repeat units. This polymer is referred to herein as the “T5” polymer.

In some embodiments, the polyanionic polymer comprises: 45% maleic repeat units, 35% itaconic repeat units, 15% methallylsulfonate repeat units, and 5% allylsulfonate repeat units.

In some embodiments, the polyanionic polymer comprises: 45% maleic repeat units, 50% itaconic repeat units, 4% methallylsulfonate repeat units, and 1% allylsulfonate repeat units.

In some embodiments, the polyanionic polymer is in a full or partial salt form. Exemplary salt forms include, but are not limited to, a sodium, potassium, lithium, cesium, magnesium, calcium, or a combination thereof. In some embodiments, the polyanionic polymer is a T5 tetrapolymer in a full or partial salt form.

In some embodiments, the nitrapyrin-organic acid ionic mixture contains from about 50 g/mol anionic species to about 200 g/mol anionic species; or from about 75 g/mol anionic species to about 190 g/mol anionic species; or from about 100 g/mol anionic species to about 180 g/mol anionic species; or about 125 g/mol anionic species to about 175 g/mol anionic species.

In some embodiments, nitrapyrin can be present in the ionic mixture as nitrapyrin that forms a complex with the organic acid and as a nitrapyrin that is in the free form (i.e., nitrapyrin that is not complexed). The ratio of complex to free form can be from 1000:1 to 0.1:1 such that the compositions can reduce the volatilization losses of nitrapyrin to atmosphere by at least 10% as compared to an identical composition lacking the complex described herein. Accordingly, the compositions described herein can simultaneously comprise the complex and the free form so long as the volatilization losses are reduced as described elsewhere herein.

In some embodiments, the nitrapyrin-organic acid ionic mixture further comprises one or more additives. In some embodiments, the additive is a surface active agent (e.g., a surfactant). In some embodiments, the surface active agent is selected from polyoxyethylene tridecyl ether phosphate (Rhodafac RS-610), sodium tetraborate, sodium gluconate, sodium monolaurate (SPAN® 20) propylene oxide ethylene oxide polymer monobutyl ether (Antarox B848), a mixture of castor oil, ethoxylated, oleate (Alkamuls VO/2003), 4-dodecylbenzenesulfonic acid and salts thereof (e.g., dodecylbenzenesulfonate, sodium salt, etc.), and a combination thereof. The amount of surface active agent in the composition can vary. In some embodiments, the amount of surface active agent in the composition is from about 0.1% to about 25%, from about 1% to about 20%, from about 5% to about 20%, from about 1% to about 10%, or from about 1% to about 6% (or less than about 10%, 9%, 8%, 7%, 6%, 5%, 4%, 3% or about 2% by weight) by weight based on the total weight of the composition. In some embodiments, the amount of surface active agent in the composition is from about 10% to about 25%, from about 15% to about 25%, from about 17% to about 23%, or from about 18% to about 20% (or less than about 25%, 24%, 23%, 22%, 21%, 20%, 19%, 18%, 17%, 16%, 15%, 14%, 13%, 12%, or less than 11% by weight) by weight based on the total weight of the composition.

B. Organic Solvents

In some embodiments, the solvent is an organic solvent. In some embodiments, the solvent is one or more polar organic solvent(s). In some embodiments, the one or more polar organic(s) solvent are EPA approved. EPA-approved solvents are those that are approved for food and non-food use and found in the electronic code of federal regulations, for example in Title 40, Chapter I, Subchapter E, Part 180. EPA-approved solvent include, but are not limited to, the solvents listed in Table 1.

TABLE 1
EPA-approved solvents

1,3-Propanediol (CAS Reg. No. 504-63-2)
2-Ethylhexanol
2-methyl-1,3-propanediol (CAS Reg. No. 2163-42-0)
2-Methyl-2,4-pentanediol
Acetic anhydride
Acetone (CAS Reg. No. 67-64-1)
Ammonium hydroxide
Amyl acetate
Benzyl acetate (CAS Reg. No. 140-11-4)
C₁₀₋₁₁ rich aromatic hydrocarbons (CAS Reg. No. 64742-94-5)
C₁₁₋₁₂ rich aromatic hydrocarbons (CAS Reg. No. 64742-94-5)
C₉ rich aromatic hydrocarbons (CAS Reg. No. 64742-95-6)
Choline chloride (CAS Reg. No. 67-48-1)
Cod liver oil
Cyclohexane
Cyclohexanone
Decanamide, N,N-dimethyl (CAS Reg. No. 14433-76-2)
Diethylene Glycol (CAS No. 111-46-6)
Diethylene glycol mono butyl ether (CAS Reg. No. 112-34-5)
Diethylene Glycol MonoEthyl Ether (CAS Reg. No. 111-90-0)
Diethylphthalate
Diisopropyl adipate (CAS Reg. No. 6938-94-9)
Dimethyl adipate (CAS Reg. No. 627-93-0)
Dimethyl glutarate (CAS Reg. No. 1119-40-0)
Dimethyl succinate (CAS Reg. No. 106-65-0)
Dimethyl sulfoxide (CAS Reg. No. 67-68-5)
Di-n-butyl carbonate (CAS Reg. No. 542-52-9)
Dipropylene glycol
Distillates, (Fishcher-Tropsch), heavy, C₁₈-C₅₀, branched, cyclic and
linear (CAS Reg. No. 848301-69-9)
d-Limonene (CAS Reg. No. 5989-27-5)
Edible fats and oils
Ethyl acetate
Ethyl alcohol
Ethyl esters of fatty acids derived from edible fats and oils
Ethylene glycol (CAS Reg. No. 107-21-1)
Glycerol mono-, di-, and triacetate
Hydrochloric acid
Isobornyl acetate
Isobutyl acetate (CAS Reg. No. 110-19-0)
Isobutyl isobutyrate (CAS Reg. No. 97-85-8)
Isobutyric acid (CAS Reg. No. 79-31-2)
Isopropyl myristate (CAS Reg. No. 110-27-0)
Isopropyl-3-hydroxybutyrate (CAS Reg. No. 54074-94-1)
Kerosene, U.S.P. reagent
Lactic acid
Lactic acid, 2-ethylhexyl ester (CAS Reg. No. 6283-86-9)
Lactic acid, n-propyl ester, (S); (CAS Reg. No. 53651-69-7)
Mesityl oxide
Methyl 5-(dimethylamino)-2-methyl-5- oxopentanoate (1174627-68-9)
Methyl alcohol
Methyl esters of fatty acids derived from edible fats and oils
Methyl isobutyl ketone
Methyl isobutyrate (CAS Reg. No. 547-63-7)
Methyl n-amyl ketone (CAS Reg. No. 110-43-0)
Mineral oil
Morpholine 4-C₆₋₁₂ Acyl Derivatives (CAS Reg. No. 887947-29-7)
n-Butanol (CAS Reg. No. 71-36-3)
n-Butyl benzoate (CAS Reg. No. 136-60-7)
n-Butyl-3-hydroxybutyrate (CAS Reg. No. 53605-94-0)
n-Decyl alcohol (CAS Reg. No. 112-30-1)
n-Hexyl alcohol (CAS Reg. No. 111-27-3)
N-Methylpyrrolidone (CAS Reg. No. 872-504)
n-Octyl alcohol (CAS Reg. No. 111-87-5)
n-Propanol
Octanamide, N,N-dimethyl (CAS Reg. No. 1118-92-9)
Oxo-decyl acetate (CAS reg. No. 108419-33-6)
Oxo-heptyl acetate (CAS Reg. No. 90438-79-2)
Oxo-hexyl acetate (CAS Reg. No. 88230-35-7)
Oxo-nonyl acetate (CAS Reg. No. 108419-34-7)
Oxo-octyl acetate (CAS Reg. No. 108419-32-5)
Oxo-tridecyl acetate (CAS Reg. No. 108419-35-8)
Petroleum hydrocarbons, light odorless conforming to 21 C.F.R. §
172.884
Phenol
Propanoic acid, 2-methyl-, monoester with 2,2,4-trimethyl-1,3-
pentanediol (CAS Reg. Reg. No. 25265-77-4)
Propylene glycol
Propylene glycol monomethyl ether (CAS Reg. No. 107-98-2)
Soybean oil-derived fatty acids
Tall oil fatty acid (CAS Reg. No. 61790-12-3)
Tetraethylene glycol (CAS Reg. No. 112-60-7)
Toluenesulfonic acid
Triacetin (glyceryl triacetate)
Xylene
γ-Butyrolactone

In some embodiments, the organic solvent is selected from a sulfone, a sulfoxide, an oil, an aromatic solvent, a halogenated solvent, a glycol-based solvent, a fatty acid-based solvent, an acetate-containing solvent, a ketone-containing solvent, an ether polyol-containing solvent, an amide-containing solvent, and combinations thereof. In some embodiments, the one or more organic solvent(s) are all relatively free of water. In some embodiments, the organic solvent contains less than about 10% w/w, about 9% w/w, about 8% w/w, about 7% w/w, about 6% w/w, about 5% w/w, about 4% w/w, about 3% w/w, about 2% w/w, about 1% w/w, about 0.9% w/w, about 0.8% w/w, about 0.7% w/w, about 0.6% w/w, about 0.5% w/w, about 0.4% w/w, about 0.3% w/w, or less than about 0.1% w/w of water based on the total weight of the solvent. In some embodiments, the organic solvent is a liquid at 20° C.

In some embodiments, the organic solvent is a sulfone. A sulfone solvent can be, but is not limited to, sulfolane, methyl sulfolane (3-methyl sulfolane), and dimethylsulfone, and a combination thereof. In some embodiments, the organic solvent is a sulfoxide. A sulfoxide solvent can be, but is not limited to, dimethyl sulfoxide (often referred to as methyl sulfoxide).

In some embodiments, the organic solvent is an ether-polyol. An ether-polyol solvent can be, but is not limited to, polyethylene glycols, polypropylene glycols, polyalkylene glycols, and related compounds. In some embodiments, the polyethylene glycol has two terminal alcohols (e.g., polyethylene glycol 3350). Exemplary polyethylene glycols include, but are not limited to, diethylene glycol, triethylene glycol, and a combination thereof. Exemplary polypropylene glycols include, but are not limited to, dipropylene glycol, tripropylene glycol, and a combination thereof. In some embodiments, a polypropylene glycol has three terminal alcohols. Exemplary polypropylene glycols having three terminal alcohols, known as propoxylated glycerol, include, but are not limited to, Dow PT250 (which is a glyceryl ether polymer containing three terminal hydroxyl groups with a molecular weight of 250) and Dow PT700 (which is a glyceryl ether polymer containing three terminal hydroxyl groups with a molecular weight of 700). In some embodiments, ether polyol comprises a polyethylene or a polypropylene glycol in the molecular weight range of between about 200 and about 10,000 Da. In some embodiments, one or more of the hydroxyl groups present in the ether polyol is modified. For example, in some embodiments, one or more of the hydroxyl groups present in the ether polyol are alkylated and/or esterified. Exemplary modified ether polyols include, but are not limited to, triacetin, n-butyl ether of diethylene glycol, ethyl ether of diethylene glycol, methyl ether of diethylene glycol, acetate of the ethyl ether of dipropylene glycol, and a combination thereof. In some embodiments, the ether polyol is a cyclic carbonate ester (e.g., propylene carbonate). In some embodiments, the ether polyol is polyethylene glycol 400. In some embodiments, the ether polyol if polyethylene glycol 3350. It has been found that the disclosed compositions containing ether polyols are more suitable for formation of higher solids and/or actives content than previously described compositions containing esters.

In some embodiments, the organic solvent is a glycol-based solvent. A glycol is an alcohol that contains two hydroxyl (—OH) groups that are attached to different carbon atoms (e.g., terminal carbon atoms). The simplest glycol is ethylene glycol, although the solvent should not be limited thereto. In some embodiments, the organic solvent is propane-1,2,3-triol.

In some embodiments, the organic solvent is an oil. Exemplary oils include, but are not limited to, mineral oil and/or kerosene.

In some embodiments, the organic solvent is a fatty acid-based solvent. In some embodiments, the fatty acid contains between 3 to about 20 carbon atoms. An example of a fatty acid-based solvent include, but are not limited to, a dialkyl amide of a fatty acid (e.g., a dimethylamide). Examples of a dimethylamide of a fatty acid include, but are not limited to, a dimethyl amide of a caprylic acid, a dimethyl amide of a C8-C10 fatty acid (Agnique® AMD810 (N,N-dimethyloctanamide, CAS Numbers 1118-92-9 and N,N-dimethyldecanamide, CAS Number 14433-76-2)), a dimethyl amide of a natural lactic acid (Agnique® AMD3L (N,N-dimethylactamide; CAS Number 35123-06-9), and a combination thereof.

In some embodiments, the organic solvent is a ketone-containing solvent. Examples of ketone-containing solvent include, but are not limited to, isophorone, trimethylcyclohexanone, and a combination thereof.

In some embodiments, the organic solvent is an acetate-containing solvent. Examples of acetate-containing solvents include, but are not limited to, acetate, hexyl acetate, heptyl acetate, and a combination thereof.

In some embodiments, the organic solvent is an amide-containing solvent. Examples of amide-containing solvents include, but are not limited to, Rhodiasolv® ADMA10 (CAS Reg. No. 14433-76-2; N,N-dimethyloctanamide), Rhodiasolv® AMD810 (CAS Reg. No. 1118-92-9/14433-76-2; blend of N,N-dimethyloctanamide and N,N-dimethyldecanamide), Rhodiasolv® PolarClean (CAS Reg. No. 1174627-68-9; methyl 5-(dimethylamino)-2-methyl-5-oxopentanoate), and a combination thereof.

In some embodiments, the organic solvent is a halogentated solvent. In some embodiments, the halogentated solvent is a halogentated aromatic hydrocarbon. An example of a halogenated aromatic hydrocarbon is chlorobenzene. In some embodiments, the halogentated solvent is a halogentated aliphatic hydrocarbon. An example of a halogenated aliphatic hydrocarbon is 1,1,1-trichloroethane.

In some embodiments, the organic solvent is an aromatic solvent. In some embodiments, the aromatic solvent is an aromatic hydrocarbon. Exemplary aromatic hydrocarbons include, but are not limited to, benzene, naphthylene, and a combination thereof. In some embodiments, the aromatic hydrocarbon is substituted. Examples of substituted aromatic hydrocarbons include, but are not limited to, alkyl substituted benzenes and/or alkyl substituted naphthalenes. Examples of alkyl substituted benzenes include xylene, toluene, propylbenzene, and a combination thereof. In some embodiments, the organic solvent comprises xylene. In some embodiments, the aromatic hydrocarbon is a mixture of substituted and unsubstituted aromatic hydrocarbons, such as, but not limited to a mixture of naphthenic and alkyl substituted naphthalene.

In some embodiments, the aromatic solvent is a mixture of hydrocarbons. For example, in some embodiments, the aromatic solvent is aromatic 100, a solvent containing Naphtha (CAS No. 64742-95-6), which is a combination of hydrocarbons obtained from distillation of aromatic streams consisting predominantly of aromatic hydrocarbons C₈ through C₁₀), or aromatic 200, a solvent containing a mixture of: aromatic hydrocarbon (C₁₁-C₁₄) present in 50-85% by weight; Naphthalene (CAS No. 91-20-3) present in 5-20% by weight; aromatic hydrocarbon (C₁₀) not including naphthalene present in 5-15% by weight; and aromatic hydrocarbon (C₁₅-C₁₆) present in 5-15% by weight based on the total weight of the aromatic 200 composition. In some embodiments, the aromatic hydrocarbon is a mixture of aromatic 100 and aromatic 200.

In some embodiments, an organic solvent can be, but is not limited to, an aromatic solvent (such as but not limited to, alkyl substituted benzene, xylene, propyl benzene, dimethylbenzene, mixed naphthalene and alkyl naphthalene); and mineral oils; kerosene; dialkyl amides of fatty acids, (including, but not limited to, dimethylamides of fatty acids, dimethyl amide of caprylic acid); chlorinated aliphatic and aromatic hydrocarbons (including, but not limited to, 1,1,1-trichloroethane, chlorobenzene); esters of glycol derivatives (e.g., n-butyl, ethyl, or methyl ether of diethyleneglycol and acetate of the methyl ether of dipropylene glycol); ketone-containing solvents (e.g., including, but not limited to, isophorone and trimethylcyclohexanone (dihydroisophorone)); and acetate-containing solvents (including, but not limited to, hexyl and heptyl acetate).

In some embodiments, an organic solvent can be, but is not limited to, aromatic 100, aromatic 200, a sulfone, a sulfoxide, xylenes, glycol-based solvent, a ether-polyol and/or polyglycol (e.g., dipropylene glycol, Dow PT250, Dow PT700, PT250, triethylene glycol, tripropylene glycol, propane-1,2,3-triol, polyethylene glycol 3350, polyethylene glycol 400 propylene carbonate, triacetin), dialkylamides of saturated monocarboxylic fatty acids containing between 3 and 20 carbon atoms (such as Agnique® AMD810, Agnique® AMD3L), amide-containing solvent (e.g., Rhodiasolv® ADMA10, Rhodiasolv® PolarClean and Rhodiasolv® ADMA810), dialkylamides of alpha-hydroxycarboxylic acids containing between 2 and 10 carbon atoms, such as Agnique® AMD3L, Rhodiasolv® PolarClean, heavy aromatic solvent naphtha, dimethylbenzene, or mixtures thereof. In some embodiments, the organic solvent is selected from Agnique® AMD810, Agnique® AMD3L, Rhodiasolv® ADMA10, Rhodiasol® ADMA810, Rhodiasol® PolarClean (methyl 5-(dimethylamino)-2-methyl-5-oxopentanoate), dimethyl sulfoxide, propane-1,2,3-triol, polyethylene glycol 3350, polyethylene glycol 400, xylenes, and mixtures thereof. In some embodiments, the organic solvent comprises dimethylsulfoxide and Rhodiasolv® PolarClean. In some embodiments, the organic solvent comprises dimethylsulfoxide, propane-1,2,3-triol, and Rhodiasolv® PolarClean. In some embodiments, the organic solvent comprises dimethylsulfoxide, polyethylene glycol (e.g., polyethylene glycol 400 and/or 3350), heavy aromatic solvent naphtha, dimethylbenzene, and Rhodiasolv® PolarClean. In some embodiments, the organic solvent comprises dimethylsulfoxide and xylenes.

In some embodiments, the organic solvent is relatively free of water. In some embodiments, the organic solvent contains less than about 10% w/w, about 9% w/w, about 8% w/w, about 7% w/w, about 6% w/w, about 5% w/w, about 4% w/w, about 3% w/w, about 2% w/w, about 1% w/w, about 0.9% w/w, about 0.8% w/w, about 0.7% w/w, about 0.6% w/w, about 0.5% w/w, about 0.4% w/w, about 0.3% w/w, or less than about 0.1% w/w of water based on the total weight of the solvent.

In some embodiments, the composition containing the nitrapyrin-ionic mixture can be formulated with two or more different solvent types. The nitrapyrin-organic acid ionic mixture can be formulated in two different solvent types that can exhibit high solvation, lack of volatility, reduced corrosion behavior, and suitable environmental and toxicological profiles. The two different solvent types can be selected from two different aromatic solvents, two different sulfones, two different amide-containing solvents, two different ether polyols, two different sulfoxides, two different amide-containing solvents, two different fatty acid-based solvents, or a sulfoxide and an aromatic solvent, or a sulfoxide and an amide-containing solvent or a sulfoxide and an ether polyol. In some embodiments, the two different solvent types are xylenes and dimethylsulfoxide. In some embodiments, the xylene is further mixed with ethylbenzene. In some embodiments, the two different solvent types are dimethyl sulfoxide and Rhodiasolv® PolarClean. In some embodiments, the two different solvent types are dimethyl sulfoxide and propane-1,2,3-triol. In some embodiments, dimethyl sulfoxide and propane-1,2,3-triol are further mixed with Rhodiasolv® PolarClean to render a formulation containing three different solvent types. In some embodiments, dimethyl sulfoxide, propane-1,2,3-triol and Rhodiasolv® PolarClean are further mixed with polyethylene glycol 400 or 3350 to render a formulation containing four different solvent types. The amount of each solvent type present in the composition can vary. In some embodiments, the first solvent of the two or more different solvent types is present in an amount ranging from about 10% to about 90%, from about 10% to about 80%, from about 15% to about 70%, from about 15% to about 60% w/w, from about 15% to about 50%, from about 15% to about 40%, from about 15% to about 35%, from about 20% to about 35%, from about 25% to about 35%, from about 15% to about 25%, from about 15% to about 20%, or from about 27% to about 32% based on the total weight of the composition. In some embodiments, the second solvent of the two or more different solvent type is present in an amount ranging from about 10% to about 90%, from about 10% to about 80%, from about 15% to about 70%, from about 15% to about 60% w/w, from about 15% to about 50%, from about 15% to about 40%, from about 15% to about 35%, from about 20% to about 35%, from about 25% to about 35%, from about 15% to about 25%, from about 15% to about 20%, or from about 27% to about 32% based on the total weight of the composition. In some embodiments, the first solvent and the second solvent are each present in an amount ranging from about 25% to about 35% by weight based on the total weight of the composition. In some embodiments, the first solvent and the second solvent are each present in an amount ranging from about 15% to about 20% by weight based on the total weight of the composition. In some embodiments, the composition comprises a third solvent. In such embodiments, the third solvent is present in an amount ranging from about 1% to about 10%, from about 1% to about 8%, or from about 1% to about 3% by weight based on the total weight of the composition. In some embodiments, the composition comprises a fourth solvent. In such embodiments, the fourth solvent is present in an amount ranging from about 1% to about 10%, from about 3% to about 8%, or from about 5% to about 8% by weight based on the total weight of the composition.

In some embodiments, solvency of the nitrapyrin in solution/solvent at 20° C. is greater than 15% w/w (nitrapyrin to total weight), for example from about 15 to about 22% w/w, or about 17% to about 21% w/w, or greater than 16% w/w, greater than 17% w/w, greater than 18% w/w, greater than 19% w/w, greater than 20% w/w, greater than 21% w/w, greater than 22% w/w, greater than 23% w/w, greater than 24% w/w, or greater than 25% w/w greater than 26% w/w, greater than 27% w/w, greater than 28% w/w, greater than 29% w/w, greater than 30% w/w, greater than 35% w/w, greater than 40% w/w, or greater than 45% w/w.

The solvent can be present in the composition at an amount from 0.1% w/v to about 99.9% w/v. In some embodiments, the amount of solvent will be minimized as the amount of nitrapyrin-organic acid ionic mixture is maximized. In some embodiments, the amount of solvent is less than 80% w/v, less than 79% w/v, less than 78% w/v, less than 77% w/v, less than 76% w/v, less than 75% w/v, less than 74% w/v, less than 73% w/v, less than 72% w/v, less than 71% w/v, less than 70% w/v, less than 65% w/v, less than 60% w/v, or less than 55% w/v. In embodiments, the amount of solvent is from 55% w/v to about 98% w/v; or from about 60% w/v to about 97% w/v; or from about 61% w/v to about 95% w/v; or from about 62% w/v to about 90% w/v; or from about 63% w/v to about 85% w/v; or from about 64% w/v to about 80% w/v. In some embodiments, the amount of solvent is from about 10% w/v to about 90% w/v, from about 20% w/v to about 80% w/v, from about 50% w/v to about 70% w/v, or from about 60% w/v to about 70% w/v. In some embodiments, the amount of solvent is from about 10% w/v to about 50% w/v, or from about 10% w/v to about 40% w/v, or from about 10% w/v to about 30% w/v, or from about 10% w/v to about 20% w/v. In some embodiments, the amount of solvent is from about 50% w/v to about 90% w/v, or from about 50% w/v to about 80% w/v, or from about 50% w/v to about 70% w/v, or from about 50% w/v to about 65% w/v.

The composition comprises nitrapyrin in the form of an ionic mixture with an organic acid. Advantageously, nitrapyrin-organic acid ionic mixtures have been found to provide excellent loading heretofore not disclosed. Advantages of the highly concentrated compositions include lower cost of shipping and ease of handling as well as a low use rate. In embodiments, the compositions comprise nitrapyrin in a range from about 20% to about 50% by wt. based on the total weight of the composition. In some embodiments, the compositions comprise nitrapyrin in a range from about 21% to about 49% by wt. based on the total weight of the composition. In some embodiments, the compositions comprise nitrapyrin in a range from about 22% to about 48% by wt. based on the total weight of the composition. In some embodiments, the compositions comprise nitrapyrin in a range from about 23% to about 47% by wt. based on the total weight of the composition. In some embodiments, the compositions comprise nitrapyrin in a range from about 24% to about 46% by wt. based on the total weight of the composition. In some embodiments, the compositions comprise nitrapyrin in a range from about 25% to about 45% by wt. based on the total weight of the composition. In some embodiments, the compositions comprise nitrapyrin in a range from about 20% to about 40% by wt. based on the total weight of the composition. In some embodiments, the compositions comprise nitrapyrin in a range from about 20% to about 35% by wt. based on the total weight of the composition. In some embodiments, the compositions comprise nitrapyrin in a range from about 23% to about 30% by wt. based on the total weight of the composition. In some embodiments, the compositions comprise nitrapyrin in a range from about 25% to about 28% by wt. based on the total weight of the composition. In some embodiments, the compositions comprise nitrapyrin in an amount of about 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50% by wt. based on the total weight of the composition.

In some embodiments, the amount of organic acid in the composition comprises nitrapyrin-organic acid ionic mixture can vary. In some embodiments, the amount of organic acid present in the composition ranges from about 0.01% to about 20%, from about 0.5 to about 15%, from about 5% to about 15%, from about 5% to about 10%, from about 8% to about 12%, or from about 6% to about 9% by weight (or less than about 20%, about 15%, about 14%, about 13%, about 12%, about 11%, about 10%, about 9%, about 8%, about 7%, about 6%, about 5%, about 4%, about 3%, about 2%, or less than about 1.5% by weight) based on the total weight of the composition.

In some embodiments, compositions containing nitrapyrin-organic acid ionic mixtures are more readily dissolved in appropriate solvents when compared to nitrapyrin alone or with other formulations. Increased solubility of the nitrapyrin-organic acid ionic mixtures in appropriate solvents provides compositions with a higher loading and/or concentration of at least about 5%, 10%, 15%, 20%, 25%, 30%, 35%, 40%, 45%, 50%, 55%, 60%, 65%, 70%, 75, 80%, 85%, 90%, or at least about 95% compared to other nitrapyrin containing formulations that do not form ionic mixtures with organic acids (e.g., N-Serve® and/or Instinct® II). In some embodiments, the composition containing nitrapyrin-organic acid ionic mixtures comprise nitrapyrin with a higher loading and/or concentration of at least about 5%, 10%, 15%, 20%, 25%, or at least about 30% (or about 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, or 30%) compared to N-Serve® (which contains nitrapyrin at a concentration of 22.2% with petroleum distillates as a solvent at a concentration of 2 lbs of active ingredient per gallon). In some embodiments, the composition containing the nitrapyrin-organic acid ionic mixture comprises nitrapyrin with a higher loading and/or concentration of about 26% compared to N-Serve®. In some embodiments, the compositions containing nitrapyrin-organic acid ionic mixtures comprise nitrapyrin with a higher loading and/or concentration of at least about 5%, 10%, 15, 20%, 25%, 30%, 35%, 40%, 50%, 55%, 60%, 65% or at least about 70% (or about 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, or about 70%) compared to Instinct® II (which contains nitrapyrin at a concentration of 16.95% using petroleum distillates as a solvent at a concentration of 1.58 lbs of active ingredient per gallon). In some embodiments, the compositions containing nitrapyrin-organic acid ionic mixture comprise nitrapyrin with a higher loading and/or concentration of about 65% compared to Instinct® II.

In some embodiments, the described nitrapyrin-organic acid ionic mixture can form solutions that are greater than or equal to 25% nitrapyrin by weight. Suitable solvents include, but are not limited to, aromatic 100, aromatic 200, sulfones, sulfoxides, amide-containing solvents, fatty acid-based solvents, and glycols.

In some embodiments, the nitrapyrin-organic acid ionic mixture and compositions comprising these ionic mixtures reduce volatility of the nitrapyrin by about 5% to about 40% relative to nitrapyrin that does not form such ionic mixtures with organic acids. In some embodiments, the nitrapyrin-organic acid ionic mixture and compositions comprising such ionic mixtures reduce volatility of the nitrapyrin by about 8% to about 35% relative to nitrapyrin that does not form an ionic mixture with an organic acid. In some embodiments, the nitrapyrin-organic acid ionic mixture and compositions comprising such ionic mixtures reduce volatility of the nitrapyrin by about 10% to about 30% relative to nitrapyrin is not mixed with an organic acid to form an ionic mixture. In some embodiments, the nitrapyrin-organic acid ionic mixture and compositions comprising such ionic mixtures reduce volatility of the nitrapyrin by about 5, 6, 7, 8, 9, 10, 11, 12, 13, 14, 15, 16, 17, 18, 19, 20, 21, 22, 23, 24, 25, 26, 27, 28, or 29% relative to nitrapyrin that is not mixed with organic acid to from an ionic mixture.

The nitrapyrin-organic acid ionic mixture exhibits significantly lower vapor pressure when compared to nitrapyrin alone or with other formulations. Lower vapor pressure reduces the volatility of the nitrapyrin by at least about 5%, 10%, 15%, 20%, 25%, 30%, 35%, 40%, 45%, 50%, 55%, 60%, 65%, 70%, 75, 80%, 85%, 90%, or at least about 95% compared to nitrapyrin contained in other formulations (e.g., N-Serve® and/or Instinct® II). In some embodiments, nitrapyrin-organic acid ionic mixtures and compositions containing nitrapyrin-organic acid ionic mixtures exhibit a vapor pressure that is about 50% less than N-Serve®. Lower vapor pressure also minimizes the loss of nitrapyrin after it has been applied to fields and/or crops thereby providing a longer duration of time where nitrapyrin is effective. In addition, nitrapyrin-organic acid ionic mixtures and compositions comprising such ionic mixtures can be applied at a significantly lower product application dose rate.

Further, the nitrapyrin-organic acid ionic mixture and/or compositions comprising the nitrapyrin-organic acid ionic mixture exhibit a chemical purity of at least about 80%, 90%, 91%, 92%, 93%, 94%, 95%, 96%, 97%, 98%, 99%, or 99.5% by weight based on the total weight of nitrapyrin-organic acid ionic mixture and/or composition thereof. In some embodiments, the chemical purity of the nitraypyrin-organic acid ionic mixture and/or composition thereof is at least 99.8% based on the total weight of the nitrapyrin-organic acid ionic mixture and/or composition thereof. In some embodiments, the chemical purity of the nitrapyrin-organic acid ionic mixture and/or compositions thereof is 100% by weight based on the total weight of nitrapyrin-organic acid ionic mixture and/or composition thereof (i.e., there are no impurities present). Chemical purity of the nitrapyrin-organic acid ionic mixture and/or compositions can be determine using known methods in the art. Such methods include, but are not limited to, boiling and/or melting point determination, colorimetric methods, and/or analytical methods such as titration, infrared spectroscopy, optical rotation, chromatography, nuclear magnetic spectroscopy, and the like. A skilled artisan would be aware of what methods to use to determine chemical purity.

In some embodiments, the nitrapyrin-organic acid ionic mixture and/or composition comprising the nitrapyrin-organic acid ionic mixture comprises one or more impurities in an amount from about 0.01% to about 20% by weight based on the total weight of the nitrapyrin-organic acid ionic mixture and/or composition. In some embodiments, the amount of the one or more impurities present in the nitrapyrin-organic acid ionic mixture and/or composition is less than about 20%, 19%, 18%, 17%, 16%, 15%, 14%, 13%, 12%, 11%, 10%, 9%, 8%, 7%, 6%, 5%, 4%, 3%, 2%, 1% or less than about 0.5% by weight based on the total weight of the nitrapyrin-organic acid ionic mixture and/or composition. In some embodiments, the one or more impurities are non-acidic and/or non-corrosive. In some embodiments, the one or more impurities are acidic and/or corrosive. Exemplary acidic and/or corrosive impurities include, but are not limited to, inorganic acids (e.g., hydrochloric acid, nitric acid, phosphoric acid, sulfuric acid, boric acid, hydrofluoric acid, hydrobromic acid, perchloric acid, and hydroiodic acid) and a combination thereof. In some embodiments, the impurity is hydrochloric acid.

In some embodiments, the chemical stability of the nitrapyrin-organic acid ionic mixtures can vary. Typically as the amount of chemical impurities present in the nitrapyrin-organic acid ionic mixtures and/or compositions thereof increases and the chemical stability of the nitrapyrin-organic acid ionic mixtures and/or composition thereof decreases. In some embodiments, the chemical purity of the nitrapyrin-organic acid ionic mixture and/or composition thereof is not 100% and one or more impurities are present. In such embodiments, the chemical stability of the impurity-containing nitrapyrin-organic acid ionic mixtures and/or composition thereof is lower compared to nitrapyrin-organic acid ionic mixtures and/or composition thereof that have no impurities. In some embodiments, the chemical stability of the impurity-containing nitrapyrin-organic acid ionic mixtures and/or composition thereof is lower in an amount of at least about 10%, about 20%, about 30%, about 40%, about 50%, about 60%, about 70%, about 80%, or at least about 90% compared to nitrapyrin-organic acid ionic mixtures and/or composition thereof that have no impurities (e.g., are pure).

Advantageously, nitrapyrin-organic acid ionic mixtures that are free of impurities and/or contain only minor amounts of acidic impurities have shown noncorrosive behavior towards materials typically used in agricultural equipment. In some embodiments, such materials are metal-based materials. In some embodiments, such material are plastic-based materials. Exhibiting noncorrosive behavior towards such materials increases the longevity of the agricultural equipment and/or any surface made of such materials.

In some embodiments, the nitrapyrin-organic acid ionic mixtures and compositions thereof exhibit reduced corrosion behavior compared to nitrapyrin formulated with other formulations. In some embodiments, nitrapyrin-organic acid ionic mixtures and compositions thereof exhibited a reduction in corrosion by at least 50%, 60%, 70%, 80%, 90%, 95%, or at least 98% compared to nitrapyrin-containing formulations that do not contain nitrapyrin-organic acid ionic mixtures (e.g., N-Serve® and/or Instinct® II).

In some embodiments, the composition comprises the following solvent-nitrapyrin-organic acid combinations: one or more of malic acid, tartaric acid, etidronic acid, succinic acid, adipic acid, sebacic acid, and/or isophthalic acid, and one or more of dipropylene glycol, PT700, PT250, triethylene glycol, tripropylene glycol, propylene carbonate, propane-1,2,3-triol, dimethyl sulfoxide, xylene, triacetin, Agnique® AMD810, Agnique® AMD3L, Rhodiasolv® ADMA10, Rhodiasolv® ADMA810 and/or Rhodiasolv® PolarClean. In some embodiments, the composition comprises the following solvent-nitrapyrin-organic acid ionic mixture combinations: one or more of malic acid, tartaric acid, etidronic acid, succinic acid, and/or adipic acid, and one or more of Agnique® AMD810, Agnique® AMD3L, Rhodiasolv® ADMA10, Rhodiasolv® ADMA810, dimethylsulfoxide, propane-1,2,3-triol, xylene, polyethylene glycol 3350, polyethylene glycol 400 and/or Rhodiasolv® PolarClean. In some embodiments, the composition further comprises one or more additives such as a surface active agent and/or a polyanionic polymer (e.g., a maleic-acrylic copolymer, a BC polymer and/or T5 polymer).

In some embodiments, the composition comprises a solvent-nitrapyrin-organic acid ionic mixture combination, wherein the organic acid is adipic acid and the solvent is Agnique® AMD3L. In some embodiments, the composition further comprises a T5 polymer.

In some embodiments, the composition comprises a solvent-nitrapyrin-organic acid ionic mixture combination, wherein the organic acid is adipic acid and the solvent is Rhodiasolv® PolarClean. In some embodiments, the composition further comprises a T5 polymer.

In some embodiments, the composition comprises a solvent-nitrapyrin-organic acid ionic mixture combination, wherein the organic acid is adipic acid and the solvent comprises Rhodiasolv® PolarClean and dimethyl sulfoxide. In some embodiments, the composition further comprises a surfactant.

In some embodiments, the composition comprises a solvent-nitrapyrin-organic acid ionic mixture combination, wherein the organic acid is adipic acid and the solvent comprises Rhodiasolv® PolarClean, propane-1,2,3-tiol, and dimethyl sulfoxide. In some embodiments, the composition further comprises polyethylene glycol 3350 or 400. In some embodiments, the composition further comprises a surfactant.

In some embodiments, the composition comprises a solvent-nitrapyrin-organic acid ionic mixture combination, wherein the organic acid is adipic acid and the solvent comprises methylsulfoxide and xylene.

### III. Agricultural Products

Any of the described nitrapyrin-organic acid ionic mixtures and compositions thereof can be combined with one or more other ingredients, selected from the group consisting of fertilizer, agriculturally active compounds, seed, compounds having urease inhibition activity, nitrification inhibition activity, pesticides, herbicides, insecticides, fungicides, miticides, and the like.

In some embodiments, the described nitrapyrin-organic acid ionic mixture and compositions thereof may be mixed with the fertilizer products, applied as a surface coating to the fertilizer products, or otherwise thoroughly mixed with the fertilizer products. In some embodiments, in such combined fertilizer/nitrapyrin-organic acid ionic mixture composition, the fertilizer is in the form of particles having an average diameter of from about powder size (less than about 0.001 cm) to about 10 mm, more preferably from about 0.1 mm to about 5 mm, and still more preferably from about 0.15 mm to about 3 mm. The nitrapyrin can be present in such combined products at a level of about 0.001 g to about 20 g per 100 g fertilizer, about 0.01 to 7 g per 100 g fertilizer, about 0.08 g to about 5 g per 100 g fertilizer, or about 0.09 g to about 2 g per 100 g fertilizer. In the case of the combined fertilizer/nitrapyrin-organic acid ionic mixture products, the combined product can be applied at a level so that the amount of nitrapyrin-organic acid ionic mixture applied is about 10-150 g per acre of soil, about 30-125 g per acre of soil, or about 40-120 g per acre of soil. The combined products can likewise be applied as liquid dispersions or as dry granulated products, at the discretion of the user. When nitrapyrin-organic acid ionic mixtures are used as a coating, the nitrapyrin-organic acid ionic mixture can comprise between about 0.005% and about 15% by weight of the coated fertilizer product, about 0.01% and about 10% by weight of the coated fertilizer product, about 0.05% and about 2% by weight of the coated fertilizer product or about 0.5% and about 1% by weight of the coated fertilizer product.

A. Fertilizers

In some embodiments, the agricultural product is a fertilizer. The fertilizer can be a solid fertilizer, such as, but not limited to a granular fertilizer, and the nitrapyrin-organic acid ionic mixture can be applied to the fertilizer as a liquid dispersion. The fertilizer can be in liquid form, and the nitrapyrin-organic acid ionic mixture can be mixed with the liquid fertilizer. The fertilizers can be selected from the group consisting of starter fertilizers, phosphate-based fertilizers, fertilizers containing nitrogen, fertilizers containing phosphorus, fertilizers containing potassium, fertilizers containing calcium, fertilizers containing magnesium, fertilizers containing boron, fertilizers containing chlorine, fertilizers containing zinc, fertilizers containing manganese, fertilizers containing copper, fertilizers containing urea and ammonium nitrite and/or fertilizers containing molybdenum materials. In some embodiments, the fertilizer is or contains urea and/or ammonia, including anhydrous ammonia fertilizer. In some embodiments, the fertilizer comprises plant-available nitrogen, phosphorous, potassium, sulfur, calcium, magnesium. or micronutrients. In some embodiments, the fertilizer is solid, granular, a fluid suspension, a gas, or a solutionized fertilizer. In some embodiments, the fertilizer comprises a micronutrient. A micronutrient is an essential element required by a plant in small quantities. In some embodiments, the fertilizer comprises a metal ion selected from the group consisting of: Fe, Mn, Mg, Zn, Cu, Ni, Co, Mo, V, and Ca. In some embodiments, the fertilizer comprises gypsum, Kieserite Group member, potassium product, potassium magnesium sulfate, elemental sulfur, or potassium magnesium sulfate. Such fertilizers may be granular, liquid, gaseous, or mixtures (e.g., suspensions of solid fertilizer particles in liquid material).

In some embodiments, the nitrapyrin-organic acid ionic mixture is combined with any suitable liquid or dry fertilizer for application to fields and/or crops.

The described nitrapyrin-organic acid ionic mixture, or compositions thereof, can be applied with the application of a fertilizer. The nitrapyrin-organic acid ionic mixture can be applied prior to, subsequent to, or simultaneously with the application of fertilizers.

Further, the described nitrapyrin-organic acid ionic mixtures or compositions thereof can be applied to fields and/or crops at varying temperatures. Advantageously, it has been found that the described nitrapyrin-organic acid ionic mixtures or compositions thereof can be applied to fields and/or crops at temperatures ranging from about below freezing (e.g., −3.5° C. or colder) to elevated temperatures reaching 35° C. or higher. In some embodiments, nitrapyrin-organic acid ionic mixtures or compositions thereof can be applied to fields and/or crops at temperatures ranging from about −20° C. to about 48° C., from about −20° C. to about 40° C., from about −20° C. to about 35° C., from about −20° C. to about 30° C., from about −20° C. to about 25° C., from about −15° C. to about 20° C., from about −10° C. to about 20° C., from about −10° C. to about 10° C., or from about −5° C. to about 5° C. (or less than about 45° C., 40° C., 35° C., 30° C., 25° C., 20° C., 15° C., 10° C., 5° C., 0° C., −5° C., −10° C., −15° C. or less than −20° C. Particularly, at colder temperatures (such as freezing and below) the described nitrapyrin-organic acid ionic mixtures or compositions thereof can be applied to fields and/or crops without experiencing any difficulties such as, but not limited to, changes in viscosity (e.g., an increase in viscosity) of the composition and/or freezing (partial or completely) and/or solidifying (partial and/or completely) and/or slush formation and/or crystal formation of the composition thereby exhibiting no freezing issues during cold temperature field applications. The ability to carry out low-temperature field applications provides the user with greater flexibility and control when planning applications throughout the calendar year. Nitrapyrin-organic acid ionic mixture-containing fertilizer compositions can be applied in any manner which will benefit the crop of interest. In some embodiments, fertilizer compositions are applied to growth mediums in a band or row application. In some embodiment, the compositions are applied throughout the growth medium prior to seeding or transplanting the desired crop plant. In some embodiment, the compositions are applied to the root zone of growing plants.

B. Seed

Some embodiments describe agricultural seeds coated with one or more of the described nitrapyrin-organic acid ionic mixtures. The nitrapyrin-organic acid ionic mixtures can be present in the seed product at a level of from about 0.001-10%, about 0.004%-2%, about 0.01% to about 1%, or from about 0.1% to about 1% by weight (or no more than about 10%, about 9%, about 8%, about 7% about 6%, about 5%, about 4%, about 3%, about 2%, about 1%, about 0.5%, about 0.1%, about 0.01% or no more than 0.001%), based upon the total weight of the coated seed product. A seed can be, but is not limited to, wheat, barley, oat, triticale, rye, rice, maize, soya bean, cotton, or oilseed rape.

C. Other

In some embodiments are described urease inhibiting compounds, nitrification inhibiting compounds, pesticides, herbicides, insecticides, fungicides, and/or miticides in combination with one or more of the described nitrapyrin-organic acid ionic mixtures. As used herein, “pesticide” refers to any agent with pesticidal activity (e.g., herbicides, insecticides, and fungicides) and is preferably selected from the group consisting of insecticides, herbicides, and mixtures thereof, but normally excluding materials which assertedly have plant-fertilizing effect, for example, sodium borate and zinc compounds such as zinc oxide, zinc sulfate, and zinc chloride. For an unlimited list of pesticides, see “Farm Chemicals Handbook 2000, 2004” (Meister Publishing Co, Willoughby, Ohio), which is hereby incorporated by reference in its entirety.

Exemplary herbicides include, but are not limited to, acetochlor, alachlor, aminopyralid, atrazine, benoxacor, bromoxynil, carfentrazone, chlorsulfuron, clodinafop, clopyralid, dicamba, diclofop-methyl, dimethenamid, fenoxaprop, flucarbazone, flufenacet, flumetsulam, flumiclorac, fluroxypyr, glufosinate-ammonium, glyphosate, halosulfuron-methyl, imazamethabenz, imazamox, imazapyr, imazaquin, imazethapyr, isoxaflutole, quinclorac, MCPA, MCP amine, MCP ester, mefenoxam, mesotrione, metolachlor, s-metolachlor, metribuzin, metsulfuron methyl, nicosulfuron, paraquat, pendimethalin, picloram, primisulfuron, propoxycarbazone, prosulfuron, pyraflufen ethyl, rimsulfuron, simazine, sulfosulfuron, thifensulfuron, topramezone, tralkoxydim, triallate, triasulfuron, tribenuron, triclopyr, trifluralin, 2,4-D, 2,4-D amine, 2,4-D ester, and the like.

Exemplary insecticides include, but are not limited to 1,2 dichloropropane, 1,3 dichloropropene, abamectin, acephate, acequinocyl, acetamiprid, acethion, acetoprole, acrinathrin, acrylonitrile, alanycarb, aldicarb, aldoxycarb, aldrin, allethrin, allosamidin, allyxycarb, alpha cypermethrin, alpha ecdysone, amidithion, amidoflumet, aminocarb, amiton, amitraz, anabasine, arsenous oxide, athidathion, azadirachtin, azamethiphos, azinphos ethyl, azinphos methyl, azobenzene, azocyclotin, azothoate, barium hexafluorosilicate, barthrin, benclothiaz, bendiocarb, benfuracarb, benoxafos, bensultap, benzoximate, benzyl benzoate, beta cyfluthrin, beta cypermethrin, bifenazate, bifenthrin, binapacryl, bioallethrin, bioethanomethrin, biopermethrin, bistrifluron, borax, boric acid, bromfenvinfos, bromo DDT, bromocyclen, bromophos, bromophos ethyl, bromopropylate, bufencarb, buprofezin, butacarb, butathiofos, butocarboxim, butonate, butoxycarboxim, cadusafos, calcium arsenate, calcium polysulfide, camphechlor, carbanolate, carbaryl, carbofuran, carbon disulfide, carbon tetrachloride, carbophenothion, carbosulfan, cartap, chinomethionat, chlorantraniliprole, chlorbenside, chlorbicyclen, chlordane, chlordecone, chlordimeform, chlorethoxyfos, chlorfenapyr, chlorfenethol, chlorfenson, chlorfensulphide, chlorfenvinphos, chlorfluazuron, chlormephos, chlorobenzilate, chloroform, chloromebuform, chloromethiuron, chloropicrin, chloropropylate, chlorphoxim, chlorprazophos, chlorpyrifos, chlorpyrifos methyl, chlorthiophos, chromafenozide, cinerin I, cinerin II, cismethrin, cloethocarb, clofentezine, closantel, clothianidin, copper acetoarsenite, copper arsenate, copper naphthenate, copper oleate, coumaphos, coumithoate, crotamiton, crotoxyphos, cruentaren A &B, crufomate, cryolite, cyanofenphos, cyanophos, cyanthoate, cyclethrin, cycloprothrin, cyenopyrafen, cyflumetofen, cyfluthrin, cyhalothrin, cyhexatin, cypermethrin, cyphenothrin, cyromazine, cythioate, d-limonene, dazomet, DBCP, DCIP, DDT, decarbofuran, deltamethrin, demephion, demephion O, demephion S, demeton, demeton methyl, demeton O, demeton O methyl, demeton S, demeton S methyl, demeton S methylsulphon, diafenthiuron, dialifos, diamidafos, diazinon, dicapthon, dichlofenthion, dichlofluanid, dichlorvos, dicofol, dicresyl, dicrotophos, dicyclanil, dieldrin, dienochlor, diflovidazin, diflubenzuron, dilor, dimefluthrin, dimefox, dimetan, dimethoate, dimethrin, dimethylvinphos, dimetilan, dinex, dinobuton, dinocap, dinocap 4, dinocap 6, dinocton, dinopenton, dinoprop, dinosam, dinosulfon, dinotefuran, dinoterbon, diofenolan, dioxabenzofos, dioxacarb, dioxathion, diphenyl sulfone, disulfiram, disulfoton, dithicrofos, DNOC, dofenapyn, doramectin, ecdysterone, emamectin, EMPC, empenthrin, endosulfan, endothion, endrin, EPN, epofenonane, eprinomectin, esfenvalerate, etaphos, ethiofencarb, ethion, ethiprole, ethoate methyl, ethoprophos, ethyl DDD, ethyl formate, ethylene dibromide, ethylene dichloride, ethylene oxide, etofenprox, etoxazole, etrimfos, EXD, famphur, fenamiphos, fenazaflor, fenazaquin, fenbutatin oxide, fenchlorphos, fenethacarb, fenfluthrin, fenitrothion, fenobucarb, fenothiocarb, fenoxacrim, fenoxycarb, fenpirithrin, fenpropathrin, fenpyroximate, fenson, fensulfothion, fenthion, fenthion ethyl, fentrifanil, fenvalerate, fipronil, flonicamid, fluacrypyrim, fluazuron, flubendiamide, flubenzimine, flucofuron, flucycloxuron, flucythrinate, fluenetil, flufenerim, flufenoxuron, flufenprox, flumethrin, fluorbenside, fluvalinate, fonofos, formetanate, formothion, formparanate, fosmethilan, fospirate, fosthiazate, fosthietan, fosthietan, furathiocarb, furethrin, furfural, gamma cyhalothrin, gamma HCH, halfenprox, halofenozide, HCH, HEOD, heptachlor, heptenophos, heterophos, hexaflumuron, hexythiazox, HHDN, hydramethylnon, hydrogen cyanide, hydroprene, hyquincarb, imicyafos, imidacloprid, imiprothrin, indoxacarb, iodomethane, IPSP, isamidofos, isazofos, isobenzan, isocarbophos, isodrin, isofenphos, isoprocarb, isoprothiolane, isothioate, isoxathion, ivermectin jasmolin I, jasmolin II, jodfenphos, juvenile hormone I, juvenile hormone II, juvenile hormone III, kelevan, kinoprene, lambda cyhalothrin, lead arsenate, lepimectin, leptophos, lindane, lirimfos, lufenuron, lythidathion, malathion, malonoben, mazidox, mecarbam, mecarphon, menazon, mephosfolan, mercurous chloride, mesulfen, mesulfenfos, metaflumizone, metam, methacrifos, methamidophos, methidathion, methiocarb, methocrotophos, methomyl, methoprene, methoxychlor, methoxyfenozide, methyl bromide, methyl isothiocyanate, methylchloroform, methylene chloride, metofluthrin, metolcarb, metoxadiazone, mevinphos, mexacarbate, milbemectin, milbemycin oxime, mipafox, mirex, MNAF, monocrotophos, morphothion, moxidectin, naftalofos, naled, naphthalene, nicotine, nifluridide, nikkomycins, nitenpyram, nithiazine, nitrilacarb, novaluron, noviflumuron, omethoate, oxamyl, oxydemeton methyl, oxydeprofos, oxydisulfoton, paradichlorobenzene, parathion, parathion methyl, penfluron, pentachlorophenol, permethrin, phenkapton, phenothrin, phenthoate, phorate, phosalone, phosfolan, phosmet, phosnichlor, phosphamidon, phosphine, phosphocarb, phoxim, phoxim methyl, pirimetaphos, pirimicarb, pirimiphos ethyl, pirimiphos methyl, potassium arsenite, potassium thiocyanate, pp′ DDT, prallethrin, precocene I, precocene II, precocene III, primidophos, proclonol, profenofos, profluthrin, promacyl, promecarb, propaphos, propargite, propetamphos, propoxur, prothidathion, prothiofos, prothoate, protrifenbute, pyraclofos, pyrafluprole, pyrazophos, pyresmethrin, pyrethrin I, pyrethrin II, pyridaben, pyridalyl, pyridaphenthion, pyrifluquinazon, pyrimidifen, pyrimitate, pyriprole, pyriproxyfen, quassia, quinalphos, quinalphos, quinalphos methyl, quinothion, rafoxanide, resmethrin, rotenone, ryania, sabadilla, schradan, selamectin, silafluofen, sodium arsenite, sodium fluoride, sodium hexafluorosilicate, sodium thiocyanate, sophamide, spinetoram, spinosad, spirodiclofen, spiromesifen, spirotetramat, sulcofuron, sulfiram, sulfluramid, sulfotep, sulfur, sulfuryl fluoride, sulprofos, tau fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetradifon, tetramethrin, tetranactin, tetrasul, theta cypermethrin, thiacloprid, thiamethoxam, thicrofos, thiocarboxime, thiocyclam, thiodicarb, thiofanox, thiometon, thionazin, thioquinox, thiosultap, thuringiensin, tolfenpyrad, tralomethrin, transfluthrin, transpermethrin, triarathene, triazamate, triazophos, trichlorfon, trichlormetaphos 3, trichloronat, trifenofos, triflumuron, trimethacarb, triprene, vamidothion, vamidothion, vaniliprole, XMC, xylylcarb, zeta cypermethrin and zolaprofos.

Exemplary fungicides include, but are not be limited to, acibenzolar, acylamino acid fungicides, acypetacs, aldimorph, aliphatic nitrogen fungicides, allyl alcohol, amide fungicides, ampropylfos, anilazine, anilide fungicides, antibiotic fungicides, aromatic fungicides, aureofungin, azaconazole, azithiram, azoxystrobin, barium polysulfide, benalaxyl, benalaxyl-M, benodanil, benomyl, benquinox, bentaluron, benthiavalicarb, benzalkonium chloride, benzamacril, benzamide fungicides, benzamorf, benzanilide fungicides, benzimidazole fungicides, benzimidazole precursor fungicides, benzimidazolylcarbamate fungicides, benzohydroxamic acid, benzothiazole fungicides, bethoxazin, binapacryl, biphenyl, bitertanol, bithionol, bixafen, blasticidin-S, Bordeaux mixture, boric acid, boscalid, bridged diphenyl fungicides, bromuconazole, bupirimate, Burgundy mixture, buthiobate, sec-butylamine, calcium polysulfide, captafol, captan, carbamate fungicides, carbamorph, carbanilate fungicides, carbendazim, carboxin, carpropamid, carvone, Cheshunt mixture, chinomethionat, chlobenthiazone, chloraniformethan, chloranil, chlorfenazole, chlorodinitronaphthalene, chloroform, chloroneb, chloropicrin, chlorothalonil, chlorquinox, chlozolinate, ciclopirox, climbazole, clotrimazole, conazole fungicides, conazole fungicides (imidazoles), conazole fungicides (triazoles), copper(II) acetate, copper(II) carbonate, basic, copper fungicides, copper hydroxide, copper naphthenate, copper oleate, copper oxychloride, copper(II) sulfate, copper sulfate, basic, copper zinc chromate, cresol, cufraneb, cuprobam, cuprous oxide, cyazofamid, cyclafuramid, cyclic dithiocarbamate fungicides, cycloheximide, cyflufenamid, cymoxanil, cypendazole, cyproconazole, cyprodinil, dazomet, DBCP, debacarb, decafentin, dehydroacetic acid, dicarboximide fungicides, dichlofluanid, dichlone, dichlorophen, dichlorophenyl, dichlozoline, diclobutrazol, diclocymet, diclomezine, dicloran, diethofencarb, diethyl pyrocarbonate, difenoconazole, diflumetorim, dimethirimol, dimethomorph, dimoxystrobin, diniconazole, diniconazole-M, dinitrophenol fungicides, dinobuton, dinocap, dinocap-4, dinocap-6, dinocton, dinopenton, dinosulfon, dinoterbon, diphenylamine, dipyrithione, disulfiram, ditalimfos, dithianon, dithiocarbamate fungicides, DNOC, dodemorph, dodicin, dodine, donatodine, drazoxolon, edifenphos, epoxiconazole, etaconazole, etem, ethaboxam, ethirimol, ethoxyquin, ethylene oxide, ethylmercury 2,3-dihydroxypropyl mercaptide, ethylmercury acetate, ethylmercury bromide, ethylmercury chloride, ethylmercury phosphate, etridiazole, famoxadone, fenamidone, fenaminosulf, fenapanil, fenarimol, fenbuconazole, fenfuram, fenhexamid, fenitropan, fenoxanil, fenpiclonil, fenpropidin, fenpropimorph, fentin, ferbam, ferimzone, fluazinam, Fluconazole, fludioxonil, flumetover, flumorph, fluopicolide, fluoroimide, fluotrimazole, fluoxastrobin, fluquinconazole, flusilazole, flusulfamide, flutolanil, flutriafol, fluxapyroxad, folpet, formaldehyde, fosetyl, fuberidazole, furalaxyl, furametpyr, furamide fungicides, furanilide fungicides, furcarbanil, furconazole, furconazole-cis, furfural, furmecyclox, furophanate, glyodin, griseofulvin, guazatine, halacrinate, hexachlorobenzene, hexachlorobutadiene, hexachlorophene, hexaconazole, hexylthiofos, hydrargaphen, hymexazol, imazalil, imibenconazole, imidazole fungicides, iminoctadine, inorganic fungicides, inorganic mercury fungicides, iodomethane, ipconazole, iprobenfos, iprodione, iprovalicarb, isopropyl alcohol, isoprothiolane, isovaledione, isopyrazam, kasugamycin, ketoconazole, kresoxim-methyl, lime sulfur (lime sulphur), mancopper, mancozeb, maneb, mebenil, mecarbinzid, mepanipyrim, mepronil, mercuric chloride (obsolete), mercuric oxide (obsolete), mercurous chloride (obsolete), metalaxyl, metalaxyl-M (a.k.a. Mefenoxam), metam, metazoxolon, metconazole, methasulfocarb, methfuroxam, methyl bromide, methyl isothiocyanate, methylmercury benzoate, methylmercury dicyandiamide, methylmercury pentachlorophenoxide, metiram, metominostrobin, metrafenone, metsulfovax, milneb, morpholine fungicides, myclobutanil, myclozolin, N-(ethylmercury)-p-toluenesulfonanilide, nabam, natamycin, nystatin, β-nitrostyrene, nitrothal-isopropyl, nuarimol, OCH, octhilinone, ofurace, oprodione, organomercury fungicides, organophosphorus fungicides, organotin fungicides (obsolete), orthophenyl phenol, orysastrobin, oxadixyl, oxathiin fungicides, oxazole fungicides, oxine copper, oxpoconazole, oxycarboxin, pefurazoate, penconazole, pencycuron, pentachlorophenol, penthiopyrad, phenylmercuriurea, phenylmercury acetate, phenylmercury chloride, phenylmercury derivative of pyrocatechol, phenylmercury nitrate, phenylmercury salicylate, phenylsulfamide fungicides, phosdiphen, phosphite, phthalide, phthalimide fungicides, picoxystrobin, piperalin, polycarbamate, polymeric dithiocarbamate fungicides, polyoxins, polyoxorim, polysulfide fungicides, potassium azide, potassium polysulfide, potassium thiocyanate, probenazole, prochloraz, procymidone, propamocarb, propiconazole, propineb, proquinazid, prothiocarb, prothioconazole, pyracarbolid, pyraclostrobin, pyrazole fungicides, pyrazophos, pyridine fungicides, pyridinitril, pyrifenox, pyrimethanil, pyrimidine fungicides, pyroquilon, pyroxychlor, pyroxyfur, pyrrole fungicides, quinacetol, quinazamid, quinconazole, quinoline fungicides, quinomethionate, quinone fungicides, quinoxaline fungicides, quinoxyfen, quintozene, rabenzazole, salicylanilide, silthiofam, silver, simeconazole, sodium azide, sodium bicarbonate[2][3], sodium orthophenylphenoxide, sodium pentachlorophenoxide, sodium polysulfide, spiroxamine, streptomycin, strobilurin fungicides, sulfonanilide fungicides, sulfur, sulfuryl fluoride, sultropen, TCMTB, tebuconazole, tecloftalam, tecnazene, tecoram, tetraconazole, thiabendazole, thiadifluor, thiazole fungicides, thicyofen, thifluzamide, thymol, triforine, thiocarbamate fungicides, thiochlorfenphim, thiomersal, thiophanate, thiophanate-methyl, thiophene fungicides, thioquinox, thiram, tiadinil, tioxymid, tivedo, tolclofos-methyl, tolnaftate, tolylfluanid, tolylmercury acetate, triadimefon, triadimenol, triamiphos, triarimol, triazbutil, triazine fungicides, triazole fungicides, triazoxide, tributyltin oxide, trichlamide, tricyclazole, tridemorph, trifloxystrobin, triflumizole, triforine, triticonazole, unclassified fungicides, undecylenic acid, uniconazole, uniconazole-P, urea fungicides, validamycin, valinamide fungicides, vinclozolin, voriconazole, zarilamid, zinc naphthenate, zineb, ziram, and/or zoxamide.

In some embodiments, the composition of the presently disclosed subject matter is a pesticide/nitrapyrin-organic acid ionic mixture-containing composition comprising a pesticide and a nitrapyrin-organic acid ionic mixture. In some embodiments, the pesticide is an herbicide, insecticide, or a combination thereof.

In some embodiments, the composition of the presently disclosed subject matter is a fungicide/nitrapyrin-organic acid ionic mixture-containing composition comprising a fungicide and a nitrapyrin-organic acid ionic mixture.

The amount of nitrapyrin-organic acid ionic mixture in the pesticide/nitrapyrin-organic acid ionic mixture containing composition and/or fungicide/nitrapyrin-organic acid ionic mixture-containing composition can vary. In some embodiments, the amount of nitrapyrin-organic acid ionic mixture is present at a level of from about 0.05-10% by weight (more preferably from about 0.1%-4% by weight, and most preferably from about 0.2-2% by weight) based upon the total weight of the pesticide/nitrapyrin-organic acid ionic mixture-containing composition or fungicide/nitrapyrin-organic acid ionic mixture-containing composition taken as 100% by weight.

Exemplary classes of miticides include, but are not be limited to botanical acaricides, bridged diphenyl acaricides, carbamate acaricides, oxime carbamate acaricides, carbazate acaricides, dinitrophenol acaricides, formamidine acaricides, isoxaline acaricides, macrocyclic lactone acaricides, avermectin acaricides, milbemycin acaricides, milbemycin acaricides, mite growth regulators, organochlorine acaricides, organophosphate acaricides, organothiophosphate acaricides, phosphonate acaricides, phosphoarmidothiolate acaricies, organitin acaricides, phenylsulfonamide acaricides, pyrazolecarboxamide acaricdes, pyrethroid ether acaricide, quaternary ammonium acaricides, oyrethroid ester acaricides, pyrrole acaricides, quinoxaline acaricides, methoxyacrylate strobilurin acaricides, teronic acid acaricides, thiasolidine acaricides, thiocarbamate acaricides, thiourea acaricides, and unclassified acaricides. Examples of miticides for these classes include, but are not limited to, to botanical acaricides—carvacrol, sanguinarine; bridged diphenyl acaricides—azobenzene, benzoximate, benzyl, benzoate, bromopropylate, chlorbenside, chlorfenethol, chlorfenson, chlorfensulphide, chlorobenzilate, chloropropylate, cyflumetofen, DDT, dicofol, diphenyl, sulfone, dofenapyn, fenson, fentrifanil, fluorbenside, genit, hexachlorophene, phenproxide, proclonol, tetradifon, tetrasul; carbamate acaricides—benomyl, carbanolate, carbaryl, carbofuran, methiocarb, metolcarb, promacyl, propoxur; oxime carbamate acaricides—aldicarb, butocarboxim, oxamyl, thiocarboxime, thiofanox; carbazate acaricides—bifenazate; dinitrophenol acaricides—binapacryl, dinex, dinobuton, dinocap, dinocap-4, dinocap-6, dinocton, dinopenton, dinosulfon, dinoterbon, DNOC; formamidine acaricides—amitraz, chlordimeform, chloromebuform, formetanate, formparanate, medimeform, semiamitraz; isoxazoline acaricides—afoxolaner, fluralaner, lotilaner, sarolaner; macrocyclic lactone acaricides—tetranactin; avermectin acaricides—abamectin, doramectin, eprinomectin, ivermectin, selamectin; milbemycin acaricides—milbemectin, milbemycin, oxime, moxidectin; mite growth regulators—clofentezine, cyromazine, diflovidazin, dofenapyn, fluazuron, flubenzimine, flucycloxuron, flufenoxuron, hexythiazox; organochlorine acaricides—bromociclen, camphechlor, DDT, dienochlor, endosulfan, lindane; organophosphate acaricides—chlorfenvinphos, crotoxyphos, dichlorvos, heptenophos, mevinphos, monocrotophos, naled, TEPP, tetrachlorvinphos; organothiophosphate acaricides—amidithion, amiton, azinphos-ethyl, azinphos-methyl, azothoate, benoxafos, bromophos, bromophos-ethyl, carbophenothion, chlorpyrifos, chlorthiophos, coumaphos, cyanthoate, demeton, demeton-O, demeton-S, demeton-methyl, demeton-O-methyl, demeton-S-methyl, demeton-S-methylsulphon, dialifos, diazinon, dimethoate, dioxathion, disulfoton, endothion, ethion, ethoate-methyl, formothion, malathion, mecarbam, methacrifos, omethoate, oxydeprofos, oxydisulfoton, parathion, phenkapton, phorate, phosalone, phosmet, phostin, phoxim, pirimiphos-methyl, prothidathion, prothoate, pyrimitate, quinalphos, quintiofos, sophamide, sulfotep, thiometon, triazophos, trifenofos, vamidothion; phosphonate acaricides—trichlorfon; phosphoramidothioate acaricides—isocarbophos, methamidophos, propetamphos; phosphorodiamide acaricides—dimefox, mipafox, schradan; organotin acaricides—azocyclotin, cyhexatin, fenbutatin, oxide, phostin; phenylsulfamide acaricides—dichlofluanid; phthalimide acaricides—dialifos, phosmet; pyrazole acaricides—cyenopyrafen, fenpyroximate; phenylpyrazole acaricides—acetoprole, fipronil, vaniliprole; pyrazolecarboxamide acaricides—pyflubumide, tebufenpyrad; pyrethroid ester acaricides—acrinathrin, bifenthrin, brofluthrinate, cyhalothrin, cypermethrin, alpha-cypermethrin, fenpropathrin, fenvalerate, flucythrinate, flumethrin, fluvalinate, tau-fluvalinate, permethrin; pyrethroid ether acaricides—halfenprox; pyrimidinamine acaricides—pyrimidifen; pyrrole acaricides—chlorfenapyr; quaternary ammonium acaricides—sanguinarine; quinoxaline acaricides—chinomethionat, thioquinox; methoxyacrylate strobilurin acaricides—bifujunzhi, fluacrypyrim, flufenoxystrobin, pyriminostrobin; sulfite ester acaricides—aramite, propargite; tetronic acid acaricides—spirodiclofen; tetrazine acaricides, clofentezine, diflovidazin; thiazolidine acaricides—flubenzimine, hexythiazox; thiocarbamate acaricides—fenothiocarb; thiourea acaricides—chloromethiuron, diafenthiuron; unclassified acaricides—acequinocyl, acynonapyr, amidoflumet, arsenous, oxide, clenpirin, closantel, crotamiton, cycloprate, cymiazole, disulfiram, etoxazole, fenazaflor, fenazaquin, fluenetil, mesulfen, MNAF, nifluridide, nikkomycins, pyridaben, sulfiram, sulfluramid, sulfur, thuringiensin, triarathene.

In some embodiments, a miticide can also be selected from abamectin, acephate, acequinocyl, acetamiprid, aldicarb, allethrin, aluminum phosphide, aminocarb, amitraz, azadiractin, azinphos-ethyl, azinphos-methyl, Bacillus thuringiensis, bendiocarb, beta-cyfluthrin, bifenazate, bifenthrin, bomyl, buprofezin, calcium cyanide, carbaryl, carbofuran, carbon disulfide, carbon tetrachloride, chlorfenvinphos, chlorobenzilate, chloropicrin, chlorpyrifos, clofentezine, chlorfenapyr, clothianidin, coumaphos, crotoxyphos, crotoxyphos+dichlorvos, cryolite, cyfluthrin, cyromazine, cypermethrin, deet, deltamethrin, demeton, diazinon, dichlofenthion, dichloropropene, dichlorvos, dicofol, dicrotophos, dieldrin, dienochlor, diflubenzuron, dikar (fungicide+miticide), dimethoate, dinocap, dinotefuran, dioxathion, disulfoton, emamectin benzoate, endosulfan, endrin, esfenvalerate, ethion, ethoprop, ethylene dibromide, ethylene dichloride, etoxazole, famphur, fenitrothion, fenoxycarb, fenpropathrin, fenpyroximate, fensulfothion, fenthion, fenvalerate, flonicamid, flucythrinate, fluvalinate, fonofos, formetanate hydrochloride, gamma-cyhalothrin, halofenozide, hexakis, hexythiazox, hydramethylnon, hydrated lime, indoxacarb, imidacloprid, kerosene, kinoprene, lambda-cyhalothrin, lead arsenate, lindane, malathion, mephosfolan, metaldehyde, metam-sodium, methamidophos, methidathion, methiocarb, methomyl, methoprene, methoxychlor, methoxyfenozide, methyl bromide, methyl parathion, mevinphos, mexacarbate, Milky Disease Spores, naled, naphthalene, nicotine sulfate, novaluron, oxamyl, oxydemeton-methyl, oxythioquinox, para-dichlorobenzene, parathion, PCP, permethrin, petroleum oils, phorate, phosalone, phosfolan, phosmet, phosphamidon, phoxim, piperonyl butoxide, pirimicarb, pirimiphos-methyl, profenofos, propargite, propetamphos, propoxur, pymetrozine, pyrethroids—synthetic: see allethrin, permethrin, fenvalerate, resmethrin, pyrethrum, pyridaben, pyriproxyfen, resmethrin, rotenone, s-methoprene, soap, pesticidal, sodium fluoride, spinosad, spiromesifen, sulfotep, sulprofos, temephos, terbufos, tetrachlorvinphos, tetrachlorvinphos+dichlorvos, tetradifon, thiamethoxam, thiodicarb, toxaphene, tralomethrin, trimethacarb, and tebufenozide.

### IV. Methods

In some embodiments, the nitrapyrin-organic acid ionic mixtures are used directly. In other embodiments, the nitrapyrin-organic acid ionic mixtures are formulated in ways to make their use convenient in the context of productive agriculture. The nitrapyrin-organic acid ionic mixtures used in these methods include the nitrapyrin-organic acid ionic mixtures as described above. The nitrapyrin complexes can be used in methods such as:

A. Methods of Improving Plant Growth and/or Fertilizing Soil

B. Methods of Inhibiting Nitrification or Ammonia Release or Evolution

C. Methods of Reducing Nitrapyrin Volatilization

D. Methods of Improving Soil Conditions

E. Methods of Preparing Nitrapyrin-Organic Acid Ionic Mixtures

A. Methods for improving plant growth comprise contacting a nitrapyrin-organic acid ionic mixture or a composition containing a nitrapyrin-organic acid ionic mixture as disclosed herein with soil. In some embodiments, the nitrapyrin-organic acid ionic mixture or composition is applied to the soil prior to emergence of a planted crop. In some embodiments, the nitrapyrin-organic acid ionic mixture is applied to the soil adjacent to the plant and/or at the base of the plant and/or in the root zone of the plant.

Methods for improving plant growth can also be achieved by applying a nitrapyrin-organic acid ionic mixture or a composition containing a nitrapyrin-organic acid ionic mixture as a seed coating to a seed in the form of a liquid dispersion which upon drying forms a dry residue. In these embodiments, seed coating provides the nitrapyrin-organic acid ionic mixture in close proximity to the seed when planted so that the nitrapyrin-organic acid ionic mixture can exert its beneficial effects in the environment where it is most needed. That is, the nitrapyrin-organic acid ionic mixture provides an environment conducive to enhanced plant growth in the area where the effects can be localized around the desired plant. In the case of seeds, the coating containing the nitrapyrin-organic acid ionic mixture provides an enhanced opportunity for seed germination, subsequent plant growth, and an increase in plant nutrient availability.

B. Methods for inhibiting/reducing nitrification or ammonia release or evolution in an affected area comprises applying a nitrapyrin-organic acid ionic mixture or composition containing a nitrapyrin-organic acid ionic mixture to the affected area. The affected area may be soil adjacent to a plant, a field, a pasture, a livestock or poultry confinement facility, pet litter, a manure collection zone, an upright walls forming an enclosure, or a roof substantially covering the area, and in such cases the nitrapyrin-organic acid ionic mixture may be applied directly to the manure in the collection zone. The nitrapyrin-organic acid ionic mixture is preferably applied at a level from about 0.005-3 gallons per ton of manure, in the form of an aqueous dispersion having a pH from about 1-5.

C. Methods of reducing nitrapyrin volatilization comprise mixing the nitrapyrin with organic acids thereby forming an ionic mixture. Nitrapyrin-organic acid ionic mixtures are less volatile compared to the nitrapyrin free base. In some embodiments, the nitrapyrin-organic acid ionic mixtures reduce volatility by about 5% to about 40%, about 8% to about 35%, or about 10% to about 30% (or by about 5, 6, 7, 8, 9, 10, 11, 12, 13, 14, 15, 16, 17, 18, 19, 20, 21, 22, 23, 24, 25, 26, 27, 28, or about 29%) relative to untreated nitrapyrin.

D. Methods for improving soil conditions selected from the group consisting of nitrification processes, urease activities, and combinations thereof, comprising the step of applying to soil an effective amount of a described nitrapyrin-organic acid ionic mixture or composition containing a nitrapyrin-organic acid ionic mixture. In some embodiments, the nitrapyrin-organic acid ionic mixture is mixed with an ammoniacal solid, liquid, or gaseous fertilizer, and especially solid fertilizers; in the latter case, the nitrapyrin-organic acid ionic mixture is applied to the surface of the fertilizer as an aqueous dispersion followed by drying, so that nitrapyrin-organic acid ionic mixture is present on the solid fertilizer as a dried residue. The nitrapyrin complex is generally applied at a level of from about 0.01-10% by weight, based upon the total weight of the nitrapyrin-organic acid ionic mixture/fertilizer product taken as 100% by weight. Where the fertilizer is an aqueous liquid fertilizer, the nitrapyrin complex is added thereto with mixing. The nitrapyrin-organic acid ionic mixture is preferably in aqueous dispersion and have a pH of up to about 3.

E. Methods of preparing a nitrapyrin-organic acid ionic mixture, comprises contacting nitrapyrin with one or more solvents to form a first mixture, contacting the first mixture with an organic acid to form an ionic mixture of nitrapyrin and an organic acid. In some embodiments, an additive such as a polyanionic polymer and/or surface active agent is added to the formed ionic mixture.

In some embodiments, the chemical purity of nitrapyrin is at least about 50%, 60%, 70%, 80%, 90%, 91%, 92%, 93%, 94%, 95%, 96%, 97%, 98%, 99%, or 99.5% by weight based on the total weight of nitrapyrin. In some embodiments, the chemical purity of nitraypyrin is at least 99.8% based on the total weight of nitrapyrin. In some embodiments, the chemical purity of nitrapyrin is 100% by weight based on the total weight of nitrapyrin (i.e., there are no impurities present). In some embodiments, the chemical purity of nitrapyrin is not 100% and one or more impurities are present. In some embodiments, the amount of the one or more impurities present in nitrapyrin can vary. In some embodiments, the amount of the one or more impurities present in nitrapyrin is from about 0.01% to about 20% by weight based on the total weight of nitrapyrin. In some embodiments, the amount of the one or more impurities present in nitrapyrin is less than about 20%, 19%, 18%, 17%, 16%, 15%, 14%, 13%, 12%, 11%, 10%, 9%, 8%, 7%, 6%, 5%, 4%, 3%, 2%, 1% or less than about 0.5% by weight based on the total weight of nitrapyrin. In some embodiments, the one or more impurities are non-acidic and/or noncorrosive. In some embodiments, the one or more impurities are acidic and/or corrosive. Exemplary acidic and/or corrosive impurities include, but are not limited to, inorganic acids (e.g., hydrochloric acid, nitric acid, phosphoric acid, sulfuric acid, boric acid, hydrofluoric acid, hydrobromic acid, perchloric acid, and hydroiodic acid), and a combination thereof. In some embodiments, the acidic and/or corrosive impurity is hydrochloric acid.

In some embodiments, the chemical purity of the organic acid is at least about 50%, 60%, 70%, 80%, 90%, 91%, 92%, 93%, 94%, 95%, 96%, 97%, 98%, 99%, or 99.5% by weight based on the total weight of the organic acid. In some embodiments, the chemical purity of the organic acid is at least 99.8% based on the total weight of the organic acid. In some embodiments, the chemical purity of the organic acid is 100% by weight based on the total weight of the organic acid (i.e., there are no impurities present). In some embodiments, the chemical purity of the organic acid is not 100% and one or more impurities are present. In some embodiments, the amount of the one or more impurities present in the organic acid can vary. In some embodiments, the amount of the one or more impurities present in the organic acid is from about 0.01% to about 20% by weight based on the total weight of the organic acid. In some embodiments, the amount of the one or more impurities present in the organic acid is less than about 20%, 19%, 18%, 17%, 16%, 15%, 14%, 13%, 12%, 11%, 10%, 9%, 8%, 7%, 6%, 5%, 4%, 3%, 2%, 1% or less than about 0.5% by weight based on the total weight of the organic acid. In some embodiments, the one or more impurities are non-acidic and/or noncorrosive. In some embodiments, the one or more impurities are acidic and/or corrosive. Exemplary acidic and/or corrosive impurities include, but are not limited to, inorganic acids (e.g., hydrochloric acid, nitric acid, phosphoric acid, sulfuric acid, boric acid, hydrofluoric acid, hydrobromic acid, perchloric acid, and hydroiodic acid). In some embodiments, the acidic and/or corrosive impurity is hydrochloric acid.

In some embodiments, the methods A, B, and D above comprise contacting a desired area with a nitrapyrin-organic acid ionic mixture at a rate of about 100 g to about 120 g per acre of the nitrapyrin-organic acid ionic mixture. The nitrapyrin-organic acid ionic mixture can, in some embodiments, be in solution at an amount of about 0.5 lbs to about 4 lbs per U.S. gallon, or from about 1 lb to about 3 lbs/per U.S. gallon, or about 2 lbs per U.S. gallon. In some embodiments, the method includes contacting the desired area at a rate of about 0.5 to about 4 qt/A, or about 1 to about 2 qt/A.

Particular embodiments of the subject matter described herein include:
1. A nitrapyrin-organic acid ionic mixture comprising nitrapyrin and an organic acid.
2. The nitrapyrin-organic acid ionic mixture of embodiment 1, wherein the organic acid comprises a di-, tri-, tetra-, penta-, hexa-, hepta-, octa-, nona-, deca-aliphatic carboxyl, an aromatic carboxyl, a di-, tri-, tetra-, penta-, hexa-, hepta-, octa-, nona-, deca-sulfonate, or a di-, tri-, tetra-, penta-, hexa-, hepta-, octa-, nona-, deca-phosphonate or an aliphatic dibasic acid.
3. A nitrapyrin-organic acid ionic mixture comprising nitrapyrin and an organic acid, wherein the organic acid comprises a di-, tri-, tetra-, penta-, hexa-, hepta-, octa-, nona-, deca-aliphatic carboxyl, an aromatic carboxyl, a di-, tri-, tetra-, penta-, hexa-, hepta-, octa-, nona-, deca-sulfonate, or a di-, tri-, tetra-, penta-, hexa-, hepta-, octa-, nona-, deca-phosphonate or an aliphatic dibasic acid.
4. The nitrapyrin-organic acid ionic mixture of any above embodiment, wherein the organic acid is selected from the list consisting of: malic acid, tartaric acid, etidronic acid, succinic acid, adipic acid, isophthalic acid, aconitic, trimesic, biphenyl-3,3′,5,5′-tetracarboxylic acid, furantetracarboxylic acid, sebacic acid, azelaic acid, isoterephtalic acid, pyromellitic acid, and mellitic acid.
5. The nitrapyrin-organic acid ionic mixture of any above embodiment, wherein the organic acid is adipic acid.
6. A noncorrosive nitrapyrin formulation comprising the nitrapyrin-organic acid ionic mixture of any above embodiment and an organic solvent.
7. The noncorrosive nitrapyrin formulation of embodiment 6, wherein the nitrapyrin-organic acid ionic mixture comprises one or more impurities in an amount of less than 2% by wt. based on the total weight of the nitrapyrin-organic acid ionic mixture.
8. The noncorrosive nitrapyrin formulation of any one of embodiments 6 and 7, wherein the one or more impurities are an inorganic acid.
9. The noncorrosive nitrapyrin formulation of embodiment 8, wherein the inorganic acid is hydrochloric acid.
10. The noncorrosive nitrapyrin formulation of any one of embodiments 6, 7, 8, and 9, wherein the organic solvent is selected from Agnique® AMD3L, Rhodiasolv® PolarClean, heavy aromatic solvent naphtha, dimethyl sulfoxide, propane-1,2,3-triol, polyethylene glycol 3350, polyethylene glycol 400, dimethylbenzene, xylenes, and mixtures thereof
11. The noncorrosive nitrapyrin formulation of any one of embodiments 6, 7, 8, 9 and 10, wherein the organic solvent is a combination of two or more polar solvents.
12. The noncorrosive nitrapyrin formulation of embodiment 11, wherein the two or more solvents comprise dimethyl sulfoxide, Rhodiasolv® PolarClean, and xylene.
13. The noncorrosive nitrapyrin formulation of any one of embodiments 6, 7, 8, 9, 10, 11, 12 and 13, wherein the formulation further comprises a surface active agent.
14. The noncorrosive nitrapyrin formulation of embodiment 13, wherein the surface active agent is selected from Rhodafac RS-610, Antarox B848, Alkamuls VO/2003, 4-dodecylbenzenesulfonic acid, sodium tetraborate, sodium gluconate, sodium monolaurate, sodium salt of dodecylbenzenesulfonic acid, and a combination thereof
15. The noncorrosive nitrapyrin formulation of embodiment 13 or 14, wherein the surface active agent comprises sodium salt of dodecylbenzenesulfonic acid.
16. The noncorrosive nitrapyrin formulation of any one of embodiments 6, 7, 8, 9, 10, 11, 12, 13, 14, and 15, wherein the nitrapyrin-organic acid ionic mixture further comprises a polyanionic polymer.
17. The noncorrosive nitrapyrin formulation of embodiment 16, wherein the polyanionic polymer is a random copolymer; and/or is a terpolymer; and/or is a tetrapolymer.
18. The noncorrosive nitrapyrin formulation of embodiment 16 or 17, wherein the polyanionic polymer has a MW/charge ratio of 45-200; and/or has a net formal charge less than −2 in dilute aqueous solution at pH 10.
19. The noncorrosive nitrapyrin formulation of any one of embodiments 16, 17 and 18, wherein the polyanionic polymer contains at least 80 mole percent repeat units containing at least one anionic group.
20. The noncorrosive nitrapyrin formulation of any one of embodiments 16, 17, 18 and 19, wherein the polyanionic polymer has a net formal charge less than −10 in dilute aqueous solution at pH 10.
21. The noncorrosive nitrapyrin formulation of any one of embodiments 16, 17, 18, 19, and 20, wherein the polyanionic polymer comprises one itaconic repeat unit, one maleic repeat unit, and two sulfonate repeat units.
22. The noncorrosive nitrapyrin formulation of any one of embodiments 16, 17, 18, 19, 20, and 21, wherein the polyanionic polymer comprises one itaconic repeat unit, one maleic repeat unit, one methallylsulfonic repeat unit, and one allylsulfonic repeat unit.
23. The noncorrosive nitrapyrin formulation of any one of embodiments 16, 17, 18, 19, 20, 21 and 22, wherein the polyanionic polymer comprises 35-50% maleic repeat units, 20-55% itaconic repeat units, 1-25% methallylsulfonic repeat units, and 1-20% allylsulfonic repeat units.
24. The noncorrosive nitrapyrin formulation of any one of embodiments 16, 17, 18, 19, 20, 21, 22 and 23, wherein the polyanionic polymer is a T5 polymer.
25. The noncorrosive nitrapyrin formulation of any one of embodiments 6-24, wherein the formulation is applied to fields and/or crops at cold temperatures without freezing, solidifying, crystalizing, or a combination thereof
26. The noncorrosive nitrapyrin formulation of any one of embodiments 6-25, wherein the formulation exhibits a reduced corrosion behavior compared to nitrapyrin formulations that do not contain nitrapyrin-organic acid ionic mixtures.
27. The noncorrosive nitrapyrin formulation of any one of embodiments 6-26, wherein the formulation exhibits a reduced corrosion behavior towards metal-based materials used in agricultural equipment.
28. The noncorrosive nitrapyrin formulation any one of embodiments 6-27, wherein the formulation exhibits reduced corrosion behavior toward metal-based components of agricultural equipment.
29. The noncorrosive nitrapyrin formulation of any one of embodiments 6-28, wherein nitrapyrin is present at a loading/concentration from about 20% to about 50% wt/wt.
30. The noncorrosive nitrapyrin formulation of any one of embodiments 6-29, wherein nitrapyrin is present at a loading that is at least about 25% higher than N-Serve®.
31. The noncorrosive nitrapyrin formulation of any one of embodiments 6-30, wherein nitrapyrin is present at a loading that is at least about 65% higher than Instinct® II.
32. The noncorrosive nitrapyrin formulation of any one of embodiments 6-31, wherein the formulation exhibits lower nitrapyrin volatility compared to formulations that do not contain a nitrapyrin-organic acid ionic mixture.
33. The noncorrosive nitrapyrin formulation of any one of embodiments 6-32, wherein the formulation exhibits 50% less volatility compared to N-Serve.
34. A composition comprising an agricultural product and the noncorrosive nitrapyrin formulation of any one of embodiments 6-33.
35. The composition of embodiment 34, wherein the agricultural product is selected from the group consisting of fertilizer, seed, urease-inhibiting compound, nitrification-inhibiting compound, pesticide, herbicide, insecticide, fungicide, and/or miticide.
36. The composition of embodiment 34 or 35, wherein the agricultural product is a fertilizer.
37. A method of fertilizing soil and/or improving plant growth and/or health comprising contacting the nitrapyrin-organic acid ionic mixture of any one of embodiments 1-5 to the soil.
38. A method of reducing nitrapyrin volatilization by mixing nitrapyrin free base with an organic acid, wherein the organic acid comprises a di-, tri-, tetra-, penta-, hexa-, hepta-, octa-, nona-, deca-aliphatic carboxyl, an aromatic carboxyl, a di-, tri-, tetra-, penta-, hexa-, hepta-, octa-, nona-, deca-sulfonate, or a di-, tri-, tetra-, penta-, hexa-, hepta-, octa-, nona-, deca-phosphonate or an aliphatic dibasic acid.
39. A method of reducing atmospheric ammonia and/or nitrification comprising contacting a formulation of any one of embodiments 6-33 with an area subject to evolution of ammonia and/or nitrification.
40. A method of inhibiting a soil condition selected from the group consisting of nitrification processes, urease activities, and combinations thereof, comprising contacting an effective amount of a nitrapyrin-organic acid ionic mixture of any one of embodiments 1-5 with the soil.
41. A method of preparing the ionic mixture of any one of embodiments 1-5, comprising contacting nitrapyrin with one or more solvents to form a first mixture, contacting the first mixture with an organic acid to form an ionic mixture of nitrapyrin and the organic acid.
42. The method of embodiment 41, wherein the nitrapyrin and/or organic acid do not contain any acidic/corrosive impurities.

### EXAMPLES

It should be understood that the following examples are provided by way of illustration only and nothing therein should be taken as a limiting.

### Example 1. Formation of Solutions of Nitrapyrin-Organic Acid Ionic Mixtures and Grading of Such Solutions

Nitrapyin and an organic acid were mixed with a solvent at room temperature as outlined in Tables 1 and 2. Solubility properties of the resulting solution was determined by using a grading system as shown in Table 3 and results were recorded in Tables 4 and 5.

TABLE 1
Nitrapyrin-organic acid ionic mixture
solutions containing 20% nitrapyrin

| | | MW (per | | g polyanion | |
|---|---|---|---|---|---|
| | # | repeat unit), | MW/ | to react 1:1 | g solvent |
| | anionic | corrected | charged | with 2.00 g | to be |
| | groups | for conc. | group | nitrapyrin | used* |
| malic | 2 | 134 | 67 | 0.580 | 7.420 |
| tartaric | 2 | 150 | 75 | 0.649 | 7.351 |
| etidronic | 4 | 343 | 86 | 0.742 | 7.258 |
| succinic | 2 | 118 | 59 | 0.511 | 7.489 |
| adipic | 2 | 146 | 73 | 0.632 | 7.368 |
| sebacic | 2 | 202 | 101 | 0.874 | 7.126 |
| isophthalic | 2 | 166 | 83 | 0.719 | 7.281 |
| maleic- | 1 | 126 | 126 | 1.091 | 6.909 |
| acrylic | | | | | |
| copolymer | | | | | |
| BC | 1 | 103 | 103 | 0.892 | 7.108 |
| T5 | 1 | 107 | 107 | 0.926 | 7.074 |

*solvents used in this study are shown in Tables 3 and 4.

TABLE 2
Component Calculations and Solvent Density

| | |
|---|---|
| Nitrapyrin, moles in 2.00 g | 0.00866 |
| BC acid density, g/ml, est. | 1.23 |
| T5 acid density, g/ml, est. | 1.20 |
| Maleic-acrylic density, g/ml | 1.23 |
| Dipropylene glycol | 1.02 g/ml |
| PT700 | 1.03 g/ml |
| PT250 | 1.09 g/ml |
| Triethylene glycol | 1.13 g/ml |
| Tripropylene glycol | 1.02 g/ml |
| Propylene carbonate | 1.21 g/ml |
| Triacetin | 1.16 g/ml |
| Agnique AMD810 | 0.88 g/ml |
| Agnique AMD3L | 1.05 g/ml |
| Rhodiasolv ADMA10 | 0.88 g/ml |
| Rhodiasolv ADM810 | 0.88 g/ml |
| Rhodiasolv PolarClean | 1.04 g/ml |

TABLE 3
Grading Scale of Solutions

| | |
|---|---|
| Fully dissolved | 5 |
| Mostly dissolved | 4 |
| Mostly not dissolved | 3 |
| Not dissolved | 2 |
| Additional precipitate | 1 |

TABLE 4
Solvent Acid Combination Table; results for reaction at 20% w/w nitrapyrin

| | | Solvent | | | | | | |
|---|---|---|---|---|---|---|---|---|
| | | dipropylene | | | triethylene | tripropylene | propylene | |
| | | glycol | PT700 | PT250 | glycol | glycol | carbonate | triacetin |
| Acid | | A | B | C | D | E | F | G |
| malic | 1 | 2 | 4 | 1 | 2 | 2 | 3 | 3 |
| tartaric | 2 | 2 | 2 | 1 | 1 | 2 | 2 | 2 |
| etidronic | 3 | 1 | 4 | 1 | 1 | 1 | 2 | 2 |
| succinic | 4 | 3 | 4 | 1 | 2 | 3 | 3 | 2 |
| adipic | 5 | 2 | 3 | 1 | 3 | 4 | 3 | 3 |
| sebaric | 6 | 1 | 2 | 1 | 2 | 1 | 2 | 2 |
| isophthalic | 7 | 2 | 2 | 1 | 1 | 4 | 3 | 3 |
| maleic-acrylic copolymer | 8 | 1 | 2 | 1 | 1 | 1 | 2 | 2 |
| BC | 9 | 1 | 4 | 1 | 1 | 1 | 2 | 2 |
| T5 | 10 | 1 | 2 | 1 | 1 | 1 | 2 | 2 |

| | | Solvent | | | | |
|---|---|---|---|---|---|---|
| | | Agnique | Agnique | Rhodiasolv | Rhodiasolv | Rhodiasolv |
| | | AMD810 | AMD3L | ADMA10 | ADMA810 | PolarClean |
| Acid | | H | I | J | K | L |
| malic | 1 | 5 | 5 | 5 | 5 | 5 |
| tartaric | 2 | 5 | 5 | 5 | 5 | 5 |
| etidronic | 3 | 4 | 5 | 5 | 4 | 5 |
| succinic | 4 | 5 | 5 | 5 | 5 | 5 |
| adipic | 5 | 5 | 5 | 5 | 5 | 5 |
| sebaric | 6 | 3 | 5 | 2 | 4 | 5 |
| isophthalic | 7 | 3 | 3 | 3 | 3 | 3 |
| maleic-acrylic copolymer | 8 | 5 | 5 | 5 | 5 | 5 |
| BC | 9 | 5 | 5 | 5 | 5 | 5 |
| T5 | 10 | 3 | 5 | 3 | 4 | 5 |

TABLE 5
Solvent acid combination, solvent volumes, 8x pipetting

| | | Solvent | | | | | | |
|---|---|---|---|---|---|---|---|---|
| | | dipropylene | | | triethylene | tripropylene | propylene | |
| | | glycol | PT700 | PT250 | glycol | glycol | carbonate | triacetin |
| Acid | | A | B | C | D | E | F | G |
| malic | 1 | 0.909 | 0.900 | 0.851 | 0.821 | 0.909 | 0.767 | 0.800 |
| tartaric | 2 | 0.901 | 0.892 | 0.843 | 0.813 | 0.901 | 0.759 | 0.792 |
| etidronic | 3 | 0.889 | 0.881 | 0.832 | 0.803 | 0.889 | 0.750 | 0.782 |
| succinic | 4 | 0.918 | 0.909 | 0.859 | 0.828 | 0.918 | 0.774 | 0.807 |
| adipic | 5 | 0.903 | 0.894 | 0.845 | 0.815 | 0.903 | 0.761 | 0.794 |
| sebaric | 6 | 0.873 | 0.865 | 0.817 | 0.788 | 0.873 | 0.736 | 0.768 |
| isophthalic | 7 | 0.892 | 0.884 | 0.835 | 0.805 | 0.892 | 0.752 | 0.785 |
| maleic-acrylic copolymer | 8 | 0.847 | 0.838 | 0.792 | 0.764 | 0.847 | 0.714 | 0.745 |
| BC | 9 | 0.871 | 0.863 | 0.815 | 0.786 | 0.871 | 0.734 | 0.766 |
| T5 | 10 | 0.867 | 0.858 | 0.811 | 0.782 | 0.867 | 0.731 | 0.762 |

| | | Solvent | | | | |
|---|---|---|---|---|---|---|
| | | Agnique | Agnique | Rhodiasolv | Rhodiasolv | Rhodiasolv |
| | | AMD810 | AMD3L | ADMA10 | ADMA810 | PolarClean |
| Acid | | H | I | J | K | L |
| malic | 1 | 1.054 | 0.883 | 1.054 | 1.054 | 0.892 |
| tartaric | 2 | 1.044 | 0.875 | 1.044 | 1.044 | 0.883 |
| etidronic | 3 | 1.031 | 0.864 | 1.031 | 1.031 | 0.872 |
| succinic | 4 | 1.064 | 0.892 | 1.064 | 1.064 | 0.900 |
| adipic | 5 | 1.047 | 0.877 | 1.047 | 1.047 | 0.886 |
| sebaric | 6 | 1.012 | 0.848 | 1.012 | 1.012 | 0.856 |
| isophthalic | 7 | 1.034 | 0.867 | 1.034 | 1.034 | 0.875 |
| maleic-acrylic copolymer | 8 | 0.981 | 0.823 | 0.981 | 0.981 | 0.830 |
| BC | 9 | 1.010 | 0.846 | 1.010 | 1.010 | 0.854 |
| T5 | 10 | 1.005 | 0.842 | 1.005 | 1.005 | 0.850 |

### Example 2. Testing of Noncorrosive Formulations

The following formulations were prepared and measured according to ASTM D-2688 standard, entitled “Corrosivity of Water in the absence of Heat Transfer (Weight Loss Methods),” for their corrosive behavior. The tests were designed to compare the nitrapyrin-organic acid ionic mixtures and compositions containing the nitrapyrin-organic acid ionic mixtures with N-Serve and/or Instinct II, the two commonly used and commercially available nitrapyrin formulations.

Formulation 1

| | |
|---|---|
| 2-Chloro-6-(trichloromethyl)pyridine | 25.00% |
| Adipic acid | 6.72% |
| Maleic-itaconic tetrapolymer, low Na salt (T5) | 1.07% |
| Dimethyl lactamide (Agnique AMD3L) | 67.21% |

Formulation 2

| | |
|---|---|
| 2-Chloro-6-(trichloromethyl)pyridine | 28.00% |
| Adipic acid | 8.90% |
| Maleic-itaconic tetrapolymer, low Na salt (T5) | 1.20% |
| Dimethyl lactamide (Agnique AMD3L) | 61.90% |

Formulation 3

| | |
|---|---|
| 2-Chloro-6-(trichloromethyl)pyridine | 28.00% |
| Adipic acid | 8.90% |
| Maleic-itaconic tetrapolymer, low Na salt (T5) | 1.20% |
| Methyl 5-(dimethylamino)-2-methyl-5-oxopentanoate | 61.90% |
| (Rhodiasolv PolarClean) | |

Formulation 4

| | |
|---|---|
| 2-Chloro-6-(trichloromethyl)pyridine | 28.00% |
| Adipic acid | 8.90% |
| Methyl 5-(dimethylamino)-2-methyl-5-oxopentanoate | 63.10% |
| (Rhodiasolv PolarClean) | |

Formulation 5

| | |
|---|---|
| 2-Chloro-6-(trichloromethyl)pyridine | 28.00% |
| Adipic acid | 8.86% |
| Polyoxyethylene tridecyl ether phosphate (Rhodafac RS-610) | 4.20% |
| Propylene oxide ethylene oxide polymer monobutyl ether | 1.80% |
| (Antarox B848) | |
| Methyl sulfoxide | 30.14% |
| Methyl 5-(dimethylamino)-2-methyl-5-oxopentanoate | 27.00% |
| (Rhodiasolv PolarClean) | |

Formulation 6

| | |
|---|---|
| 2-Chloro-6-(trichloromethyl)pyridine | 28.00% |
| Adipic acid | 8.86% |
| Castor oil, ethoxylated, oleate (Alkamuls VO/2003) | 6.00% |
| Methyl sulfoxide | 30.14% |
| Methyl 5-(dimethylamino)-2-methyl-5-oxopentanoate | 27.00% |
| (Rhodiasolv PolarClean) | |

Formulation 7

| | |
|---|---|
| 2-Chloro-6-(trichloromethyl)pyridine | 28.00% |
| Adipic acid | 8.86% |
| Polyethylene glycol 3350 | 7.50% |
| 4-Dodecylbenzenesulfonic acid | 19.00% |
| Propane-1,2,3-triol | 2.00% |
| Methyl sulfoxide | 17.32% |
| Methyl 5-(dimethylamino)-2-methyl-5-oxopentanoate | 17.32% |
| (Rhodiasolv PolarClean) | |

Formulation 8

| | |
|---|---|
| 2-Chloro-6-(trichloromethyl)pyridine | 28.00% |
| Adipic acid | 8.86% |
| Polyethylene glycol 3350 | 7.51% |
| Dodecylbenzenesulfonate, sodium salt | 18.98% |
| Propane-1,2,3-triol | 2.00% |
| Methyl sulfoxide | 17.30% |
| Methyl 5-(dimethylamino)-2-methyl-5-oxopentanoate | 17.35% |
| (Rhodiasolv PolarClean) | |

Formulation 9

| | |
|---|---|
| 2-Chloro-6-(trichloromethyl)pyridine | 28.00% |
| Adipic acid | 8.86% |
| Xylenes, mixed isomers with ethylbenzene | 31.57% |
| Methyl sulfoxide | 31.57% |

Formulation 10

| | |
|---|---|
| 2-Chloro-6-(trichloromethyl)pyridine | 28.00% |
| Adipic acid | 8.86% |
| Polyethylene glycol 400 | 7.51% |
| Dodecylbenzenesulfonate, sodium salt | 18.98% |
| Propane-1,2,3-triol | 2.00% |
| Methyl sulfoxide | 17.30% |
| Methyl 5-(dimethylamino)-2-methyl-5-oxopentanoate | 17.35% |
| (Rhodiasolv PolarClean) | |

Formulation 11

| | |
|---|---|
| 2-Chloro-6-(trichloromethyl)pyridine | 28.00% |
| Adipic acid | 8.86% |
| Polyethylene glycol 400 | 7.51% |
| Dodecylbenzenesulfonate, sodium salt | 18.98% |
| Propane-1,2,3-triol | 2.00% |
| Sodium tetraborate | 2.00% |
| Methyl sulfoxide | 16.30% |
| Methyl 5-(dimethylamino)-2-methyl-5-oxopentanoate | 16.35% |
| (Rhodiasolv PolarClean) | |

Formulation 12

| | |
|---|---|
| 2-Chloro-6-(trichloromethyl)pyridine | 28.00% |
| Adipic acid | 8.86% |
| Polyethylene glycol 400 | 7.51% |
| Dodecylbenzenesulfonate, sodium salt | 18.98% |
| Propane-1,2,3-triol | 2.00% |
| Sodium gluconate | 0.05% |
| Methyl sulfoxide | 17.275% |
| Methyl 5-(dimethylamino)-2-methyl-5-oxopentanoate | 17.325% |
| (Rhodiasolv PolarClean) | |

Formulation 13

| | |
|---|---|
| 2-Chloro-6-(trichloromethyl)pyridine | 28.00% |
| Adipic acid | 8.86% |
| Polyethylene glycol 400 | 7.51% |
| Dodecylbenzenesulfonate, sodium salt | 18.98% |
| Propane-1,2,3-triol | 2.00% |
| Sorbitan monolaurate (SPAN ® 20) | 0.30% |
| Methyl sulfoxide | 17.150% |
| Methyl 5-(dimethylamino)-2-methyl-5-oxopentanoate | 17.200% |
| (Rhodiasolv PolarClean) | |

Formulation 14

| | |
|---|---|
| 2-Chloro-6-(trichloromethyl)pyridine | 28.00% |
| Adipic acid | 8.86% |
| Polyethylene glycol 400 | 7.51% |
| Dodecylbenzenesulfonate, sodium salt | 18.98% |
| Propane-1,2,3-triol | 2.00% |
| Sorbitan monolaurate (SPAN ® 20) | 0.30% |
| Sodium gluconate | 0.05% |
| Methyl sulfoxide | 17.125% |
| Methyl 5-(dimethylamino)-2-methyl-5-oxopentanoate | 17.175% |
| (Rhodiasolv PolarClean) | |

In particular, formulations 10-14 were tested as outlined in the procedure as follows: Mild cold rolled steel coupons meeting the standard ASTM A1008/A366 measuring 3.0″×0.75″ were cleaned by submersion in acetone with gently agitation for ˜3 minutes and rinsed in deionized water. Coupons were thoroughly dried and their weight recorded. Coupons were then placed into 50 ml conical tubes with 10 grams of the various formulations and tightly capped. These samples were intermittently placed in a ˜50° C. oven (total time 31 hours) or left at room temperature (˜21° C.) for approximately 14 days. At the end of the incubation period the metal coupons were removed from the conical tubes and cleaned using deionized water and wiping with a paper towel to remove any loose particulate. The coupons were thoroughly dried and their weight recorded. Starting weight is the weight of the coupon after cleaning and before being placed in the conical tube with the formulation. Final weight is the weight of the coupon upon removal of the coupon from the formulation after incubation and after cleaning. Difference is Starting weight minus Final weight. % Change is Difference divided by Starting weight. % Improvement over control is % Change of each formulation minus % Change of control formulation 10. Table 6 shows the results obtained when testing formulations 10-14.

TABLE 6*

| | | | | | % |
|---|---|---|---|---|---|
| | Starting | Final | | % | Improvement |
| | weight | weight | Difference | Change | over control |
| Formulation 10 | 6.1655 | 6.0441 | −0.1214 | −1.97% | 0.00% |
| (control) | | | | | |
| Formulation 11 | 6.3440 | 6.3200 | −0.0240 | −0.38% | 1.59% |
| Formulation 12 | 6.1989 | 6.1593 | −0.0396 | −0.64% | 1.33% |
| Formulation 13 | 6.1724 | 6.1084 | −0.0640 | −1.04% | 0.93% |
| Formulation 14 | 6.3512 | 6.2737 | −0.0775 | −1.22% | 0.75% |

*Formulations @ 2% in UAN 32 Coupons - mild steel A366 - 1008; Coupons submerged ~¼ of their length in closed containers for ~1 day@ 50° C. and ~14 days at room temperature (~21° C.); Assay baed on ASTM D-2688 standard.

All technical and scientific terms used herein have the same meaning. Efforts have been made to ensure accuracy with respect to numbers used (e.g., amounts, temperature, etc.) but some experimental errors and deviations should be accounted for.

Throughout this specification and the claims, the words “comprise,” “comprises,” and “comprising” are used in a nonexclusive sense, except where the context requires otherwise. It is understood that embodiments described herein include “consisting of” and/or “consisting essentially of” embodiments.

As used herein, the term “about,” when referring to a value is meant to encompass variations of, in some embodiments ±5%, in some embodiments ±1%, in some embodiments ±0.5%, and in some embodiments ±0.1% from the specified amount, as such variations are appropriate to perform the disclosed methods or employ the disclosed compositions.

Where a range of values is provided, it is understood that each intervening value, to the tenth of the unit of the lower limit, unless the context clearly dictates otherwise, between the upper and lower limit of the range and any other stated or intervening value in that stated range, is encompassed. The upper and lower limits of these small ranges which may independently be included in the smaller rangers is also encompassed, subject to any specifically excluded limit in the stated range. Where the stated range includes one or both of the limits, ranges excluding either or both of those included limits are also included.

Many modifications and other embodiments set forth herein will come to mind to one skilled in the art to which this subject matter pertains having the benefit of the teachings presented in the foregoing descriptions and the associated drawings. Therefore, it is to be understood that the subject matter is not to be limited to the specific embodiments disclosed and that modifications and other embodiments are intended to be included within the scope of the appended claims. Although specific terms are employed herein, they are used in a generic and descriptive sense only and not for purposes of limitation.

1. A nitrapyrin-organic acid ionic mixture comprising nitrapyrin and an organic acid, wherein the organic acid comprises a di-, tri-, tetra-, penta-, hexa-, hepta-, octa-, nona-, deca-aliphatic carboxyl, an aromatic carboxyl, a di-, tri-, tetra-, penta-, hexa-, hepta-, octa-, nona-, deca-sulfonate, or a di-, tri-, tetra-, penta-, hexa-, hepta-, octa-, nona-, deca-phosphonate or an aliphatic dibasic acid.

2. The nitrapyrin-organic acid ionic mixture of claim 1, wherein the organic acid is selected from the list consisting of: malic acid, tartaric acid, etidronic acid, succinic acid, adipic acid, isophthalic acid, aconitic, trimesic, biphenyl-3,3′,5,5′-tetracarboxylic acid, furantetracarboxylic acid, sebacic acid, azelaic acid, isoterephtalic acid, pyromellitic acid, and mellitic acid.

3. A noncorrosive nitrapyrin formulation comprising the nitrapyrin-organic acid ionic mixture of claim 1 and an organic solvent.

4. (canceled)

5. The noncorrosive nitrapyrin formulation of claim 3, wherein the organic solvent is selected from Agnique® AMD3L, Rhodiasolv® PolarClean, dimethyl sulfoxide, propane-1,2,3-triol, polyethylene glycol 3350, polyethylene glycol 400, Heavy Aromatic Solvent Naphtha, dimethylbenzene, and mixtures thereof.

6. The noncorrosive nitrapyrin formulation of claim 3, wherein the organic solvent is a combination of two or more solvents comprising dimethyl sulfoxide, Rhodiasolv® PolarClean, Heavy Aromatic Solvent Naphtha, and xylene.

7. (canceled)

8. The noncorrosive nitrapyrin formulation of claim 3, wherein the formulation further comprises a surface active agent selected from the group consisting of Rhodafac RS-610, Antarox B848, Alkamuls VO/2003, 4-dodecylbenzenesulfonic acid, sodium tetraborate, sodium gluconate, sodium monolaurate, sodium salt of dodecylbenzenesulfonic acid, and a combination thereof.

9. (canceled)

10. (canceled)

11. The noncorrosive nitrapyrin formulation of claim 3, wherein the nitrapyrin-organic acid ionic mixture further comprises a polyanionic polymer.

12. (canceled)

13. The noncorrosive nitrapyrin formulation of claim 11, wherein the polyanionic polymer comprises one itaconic repeat unit, one maleic repeat unit, and two sulfonate repeat units.

14. The noncorrosive nitrapyrin formulation of claim 11, wherein the polyanionic polymer comprises one itaconic repeat unit, one maleic repeat unit, one methallylsulfonic repeat unit, and one allylsulfonic repeat unit.

15. The noncorrosive nitrapyrin formulation of claim 14, wherein the polyanionic polymer comprises 35-50% maleic repeat units, 20-55% itaconic repeat units, 1-25% methallylsulfonic repeat units, and 1-20% allylsulfonic repeat units.

16. The noncorrosive nitrapyrin formulation of claim 3, wherein the formulation is applied to fields and/or crops at cold temperatures without freezing, solidifying, crystalizing, or a combination thereof.

17. The noncorrosive nitrapyrin formulation of claim 3, wherein the formulation exhibits a reduced corrosion behavior compared to nitrapyrin formulations that do not contain nitrapyrin-organic acid ionic mixtures.

18. The noncorrosive nitrapyrin formulation of claim 3, wherein the formulation exhibits a reduced corrosion behavior towards metal-based materials or components used in agricultural equipment.

19. (canceled)

20. The noncorrosive nitrapyrin formulation of claim 3, wherein nitrapyrin is present at a loading/concentration from about 20% to about 50% wt/wt.

21. The noncorrosive nitrapyrin formulation of claim 3, wherein nitrapyrin is present at a loading that is at least about 25% higher than N-Serve® and/or is at least about 65% higher than Instinct® II.

22. (canceled)

23. The noncorrosive nitrapyrin formulation of claim 3, wherein the formulation exhibits lower nitrapyrin volatility compared to formulations that do not contain a nitrapyrin-organic acid ionic mixture.

24. (canceled)

25. A composition comprising an agricultural product and the noncorrosive nitrapyrin formulation of claim 3.

26. The composition of claim 25, wherein the agricultural product is selected from the group consisting of fertilizer, seed, urease-inhibiting compound, nitrification-inhibiting compound, pesticide, herbicide, insecticide, fungicide, and/or miticide.

27. (canceled)

28. (canceled)

29. A method of reducing nitrapyrin volatilization by mixing nitrapyrin free base with an organic acid, wherein the organic acid comprises a di-, tri-, tetra-, penta-, hexa-, hepta-, octa-, nona-, deca-aliphatic carboxyl, an aromatic carboxyl, a di-, tri-, tetra-, penta-, hexa-, hepta-, octa-, nona-, deca-sulfonate, or a di-, tri-, tetra-, penta-, hexa-, hepta-, octa-, nona-, deca-phosphonate or an aliphatic dibasic acid.

30. (canceled)

31. A method of inhibiting a soil condition selected from the group consisting of nitrification processes, urease activities, and combinations thereof, comprising contacting an effective amount of a nitrapyrin-organic acid ionic mixture of claim 1 with the soil.

32. (canceled)
